(19) United States
(12) Patent Application Publication
(10) Pub. No.: US 2012/0324002 A1
(43) Pub. Date: Dec. 20, 2012

(54) Media Sharing

(75) Inventor: She-Rae Chen, San Francisco, CA (US)

(73) Assignee: AFOLIO INC., San Francisco, CA (US)

(21) Appl. No.: 13/365,509

(22) Filed: Feb. 3, 2012

Related U.S. Application Data
(60) Provisional application No. 61/439,070, filed on Feb. 3, 2011.

(51) Int. Cl. G06F 15/16

(52) U.S. Cl. 709/204

(57) ABSTRACT

A method for a server to provide a media sharing service includes creating an event tag for sharing media with members of an event and receiving, from a first user on a first client device, a request to tag one or more media files with the event tag. The method further includes, in response to the request to tag the one or more media files, tagging the one or more media files with the event tag, receiving a request to access the event from a second user on a second client device, and, in response to the request to access the event, transmitting event information with copies of the one or more media files to the second client device.

### CROSS REFERENCE TO RELATED APPLICATIONS

This application claims the benefit of U.S. Provisional Application No. 61/439,070, filed Feb. 3, 2011, which is incorporated herein by reference.

### FIELD OF INVENTION

This present disclosure relates generally to a method to share media files, and more particularly to a method for users of computers and mobile devices to collectively and naturally share photos through a photo sharing service provided by a server.

### DESCRIPTION OF RELATED ART

Wikipedia describes photo sharing as the publishing or transfer of a user's digital photos online that enables the user to share them with others either publicly or privately. This function is provided through both websites and applications that facilitate the upload and display of images. Photo sharing is not confined to the web and personal computers, but is also possible from portable devices such as cameras and camera phones, using applications that can transfer photos to photo sharing sites.

### SUMMARY

In one or more embodiments of the present disclosure, a method for a server to provide a media sharing service includes creating an event tag for sharing media with members of an event and receiving, from a first user on a first client device, a request to tag one or more media files with the event tag. The method further includes, in response to the request to tag the one or more media files, tagging the one or more media files with the event tag, receiving a request to access the event from a second user on a second client device, and, in response to the request to access the event, transmitting event information with copies of the one or more media files to the second client device.

### BRIEF DESCRIPTION OF THE DRAWINGS

In the drawings:

FIG. 1 is a block diagram of an exemplary system for users of client devices to share media files;

FIG. 2 is a block diagram of exemplary data structures for storing metadata for sharing media files in a database of FIG. 1;

FIG. 3 is a flow chart of an exemplary method for the users in the system of FIG. 1 to share media files;

FIGS. 4, 5, 6, 7, and 8 are screenshots of exemplary user interfaces (UIs) for adding, tagging, and sharing photos;

FIGS. 9, 10, 11A, 11B, and 12 are screenshots of exemplary UIs for creating an event, adding photos to the event, and inviting others to the event to share the photos;

FIG. 13A is a screenshot of an exemplary UI for searching photos using tags and events;

FIG. 13B is a screenshot of an exemplary UI to add photos to an event using a mobile client application;

FIG. 14 is a screenshot of an exemplary UI for a user to request to join an event;

FIG. 15 is a flowchart of an exemplary method to create a visual representation of an event from different perspective;

FIG. 16 is a screenshot of an exemplary UI for the method of FIG. 15;

FIG. 17 is a flowchart of an exemplary method to create an invitation in the form of a machine readable code;

FIGS. 18 and 19 are screenshots of exemplary date based UI for displaying photos;

FIG. 20 is a screenshot of an exemplary user's desktop with image files the user wishes to share and organize;

FIG. 21 is a screenshot of an exemplary Afolio folder on the desktop of FIG. 20;

FIG. 22 is a screenshot of an exemplary UI for tagging image files while uploading the image files;

FIG. 23 is a screenshot of an exemplary UI illustrating a “My Photos” view after the image files have been uploaded;

FIG. 24 is a screenshot of an exemplary UI illustrating how a user shares one or more image files with an individual user, multiple users, or a group;

FIG. 25 is a screenshot of an exemplary UI illustrating how a user creates an event for sharing image files;

FIG. 26 is a screenshot of an exemplary UI illustrating an “Events”;

FIG. 27 is a screenshot of an exemplary UI illustrating how the server uses calendar and location data from third party online servers to suggest tags for a user's images file;

FIG. 28 is a screenshot of an exemplary UI illustrating how the server presents suggested tags to the user based on matches between imported calendar data and time frame of an image file;

FIG. 29 is a screenshot of an exemplary UI illustrating how a user uploads an audio file to the server, which can then be tagged to an image file;

FIG. 30 is a screenshot of an exemplary UI illustrating how the server presents an enlarged image file, including an audio file tagged to the image file and sharing history;

FIG. 31 is a screenshot of an exemplary UI illustrating an “Inbox” view;

FIGS. 32A, 32B, and 32C are flowcharts of exemplary methods for tagging image files;

FIG. 33 is a flowchart of an exemplary method for an inbox process; and

FIG. 34 is a flowchart of an exemplary method for a group invitation process, all arranged in accordance with embodiments of the present disclosure.

Use of the same reference numbers in different figures indicates similar or identical elements.

### DETAILED DESCRIPTION OF THE INVENTION

The embodiments of the present disclosure provide a collective and natural way for users to share photos and other types of media by creating an event with a photo sharing service provider. The event may be viewed by a browser application or a dedicated application. Photos may be added to the event and shared with event members by uploading new photos to the event and tagging them with an event tag or by tagging already uploaded photos with the event tag. When photos are added to the event, the event members may be notified by email with a link to the event for easy access. The email may be forwarded to a non-member, who can click on the link to the event webpage to submit a request to join the event. When an event member uses her mobile device to take photos at the physical event, the mobile device may automatically tag the photos with the event tag so they are added to the event and shared with all the event members as the event occurs. An event member may also use her mobile device to generate an invitation, and a non-member uses her mobile client device to receive the invitation and join the event.

Uploaded photos may be automatically tagged based on context, such as by matching calendar events to the taken date of the photos. The photos may be presented in a time-based fashion, such as through a calendar-like user interface (UI). The photos from multiple users may be presented together to see an event from different perspectives. In addition to text tags, a photo may be tagged with audio. For convenience, multiple photos may be selected to be downloaded either concurrently or as a single zipped file downloaded through a link. A mobile client application may play back photos with coordinated and supplemental content from a third party application.

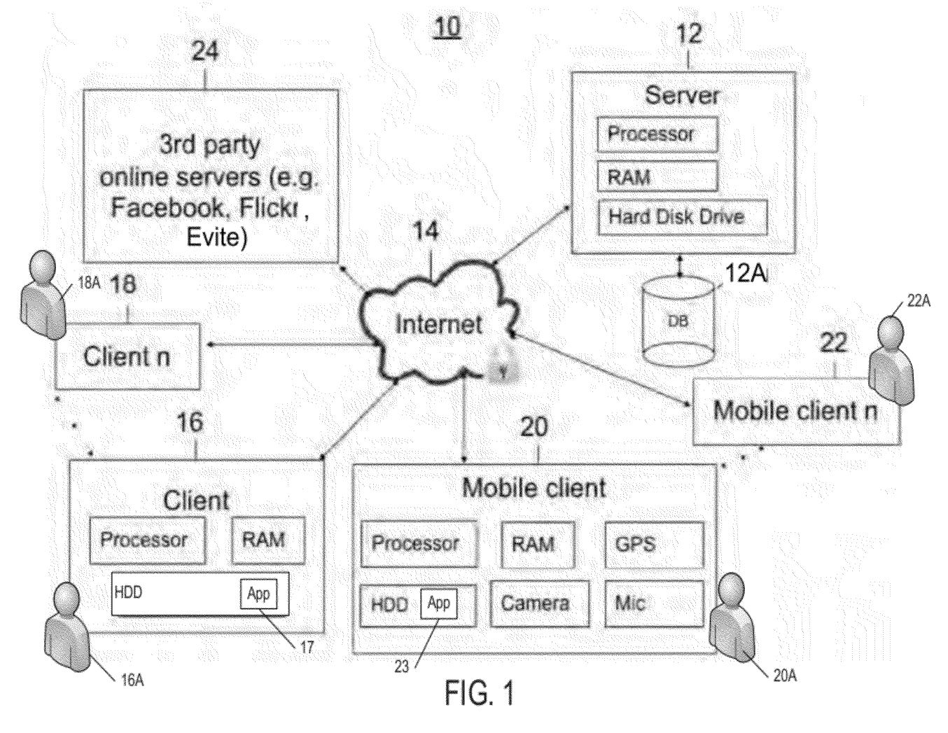

FIG. 1 is a block diagram of a system 10 for users to share their image, video, audio, text, and other types of media files in one or more embodiments of the present disclosure. The media files may be in any suitable format, including but not limited to JPEG, MP3, MPEG-4, and PDF. Hereafter image files or photos are used to demonstrate system 10 even though the system may be applied to multiple types of media. System 10 includes a server 12 that provides a photo sharing service. Server 12 hosts a website utilized by the users to share their photos. Although a single server 12 is illustrated, it may be implemented with multiple physical and virtual servers for load distribution and redundancy. Server 12 includes one or more processors, volatile memory (random access memory), and nonvolatile memory (e.g., hard disk drive). Server 12 executes one or more applications loaded from nonvolatile memory to volatile memory to implement photo sharing. Server 12 is coupled to a database 12A that stores all the system data, including the photos and their meta data. Although a single database 12A is illustrated, it may be implemented with multiple physical and virtual databases for load distribution and redundancy.

System 10 also includes one or more client devices 16 to 18 and 20 to 22 utilized by the users 16A to 18A and 20A to 22A to access the website hosted on server 12. Client devices 16 to 18 may be computers or appliances (e.g., smart television), and client devices 20 to 22 may be mobile phones and tablet devices (e.g., iPhones and iPads). Each client device includes one or more processors, volatile memory, and nonvolatile memory. Client devices 16 to 18 may each run a browser or a desktop client application 17 (only one is labeled) to interact with server 12. Client devices 20 to 22 may each include one or more of a GPS unit, a camera, and a microphone. Client devices 20 to 22 may each run a browser or a mobile client application 23 (only one is labeled) to interact with server 12.

System 10 further includes one or more third party servers 24. Third party servers 24 implement other websites, such as social networking, social planning, and photo sharing websites (e.g., Facebook, Flickr, Evite). Server 12, client devices 16 to 22, and third party servers 24 communicate over a computer network 14, such as the Internet.

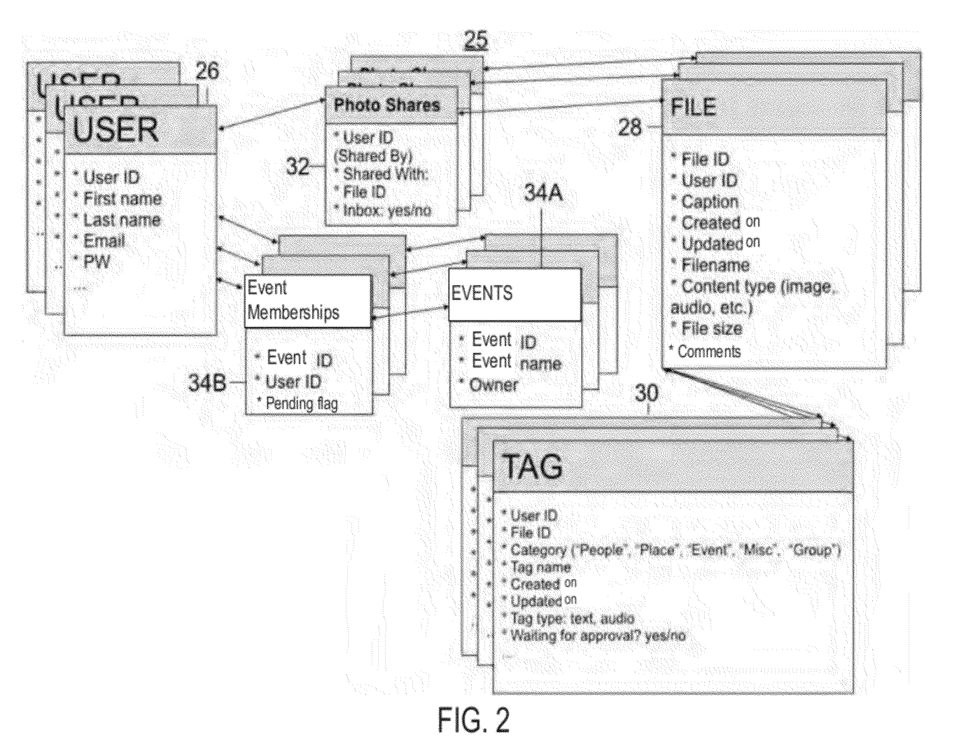

FIG. 2 illustrates data structures 25 in database 12A (FIG. 1) for storing metadata for sharing photos in one or more embodiments of the present disclosure. Data structures 25 include user tables 26, file tables 28, tag tables 30, photo shares tables 32, events tables 34A, and event memberships tables 34B.

Server 12 generates a user table 26 for each user of system 10. User table 26 includes a unique user ID, a password, and basic profile information of the user. The profile information include a user first name, a user last name, an email address, and any other demographic information that may be relevant for advertising.

Server 12 generates a file table 28 for each media file. File table 28 includes a unique file ID and a number of attributes of the media file. These file attributes include, but are not limited to, a user ID of the user that created the media file (e.g., the owner of the file), a caption, a created date and time, an updated date and time, a file name, a content type (e.g. image, video, or audio), a file size, and comments. The file attributes may also include other EXIF data from the photos.

Server 12 generates a tag table 30 for each media file. Tag table 30 includes a user ID of the user that created the tag, a file ID, a tag category (e.g., people, place, event, group, misc.), one or more tag names (e.g., an event name for an event tag), a created date and time, an updated date and time, and a tag type (e.g., text or audio). Tag table 30 may include a waiting for approval state (e.g., yes or no). The approval state indicates if an owner user approves a tag provided by a non-owner user. When the owner user approves the tag, the approval state is changed to yes and the tag appears for the file. The owner user of the file may also ignore or reject the tag provided by the non-owner user. Server 12 generates a photo shares table 32 for a user sharing a media file. Photo shares table 32 includes a user ID of a user that is sharing the media file (e.g. a shared by user), a user ID of a user that the media file may be shared with (e.g. a shared with user), and a file ID. In embodiments utilizing an inbox concept where shared files are first placed in an inbox before they are approved and moved to a shared with user's library, photo share table 32 may include an inbox state (e.g., yes or no). The inbox state is not present in embodiments where a shared file is placed automatically in a shared with user's library.

In photo share table 32 before the media file is shared, the shared with user is left blank and the optional inbox state is set to “no” so the file appears in the shared by user's own library. Server 12 also generates a photo shares table 32 for each shared with user after the file has been shared. This allows the file to be shared with other users by providing a pointer, such as the file ID in the photo share tables, so the file does not need to be duplicated in database 12A for each shared with user. In embodiments utilizing the inbox concept, the shared file appears as an item in an inbox of the shared with user when the inbox state in photo shares table 32 is set to “yes.” When the shared with user decides to add the file to her own library, server 12 changes the inbox state in photo shares table 32 from “yes” to “no” so the file is moved from the shared with user's inbox to the shared with user's library. In embodiments that do not utilize the inbox concept, a search by the shared with user will include any shared files that has tags matching the search term.

Server 12 generates a new events table 34A for each event created by a user. Events table 34A includes an event ID and attributes of the event. The event attributes include an event name and an event creator or administrator (identified by user ID). The event name may be used as the tag name of an event tag for tagging media files for sharing with members of the event. Server 12 also generates an event memberships table 34B for each event member. Event memberships table 34B includes an event ID, a user ID, and a pending flag. The pending flag is set to no or yes to indicate if an event creator has accepted a request from a non-member to join an event.

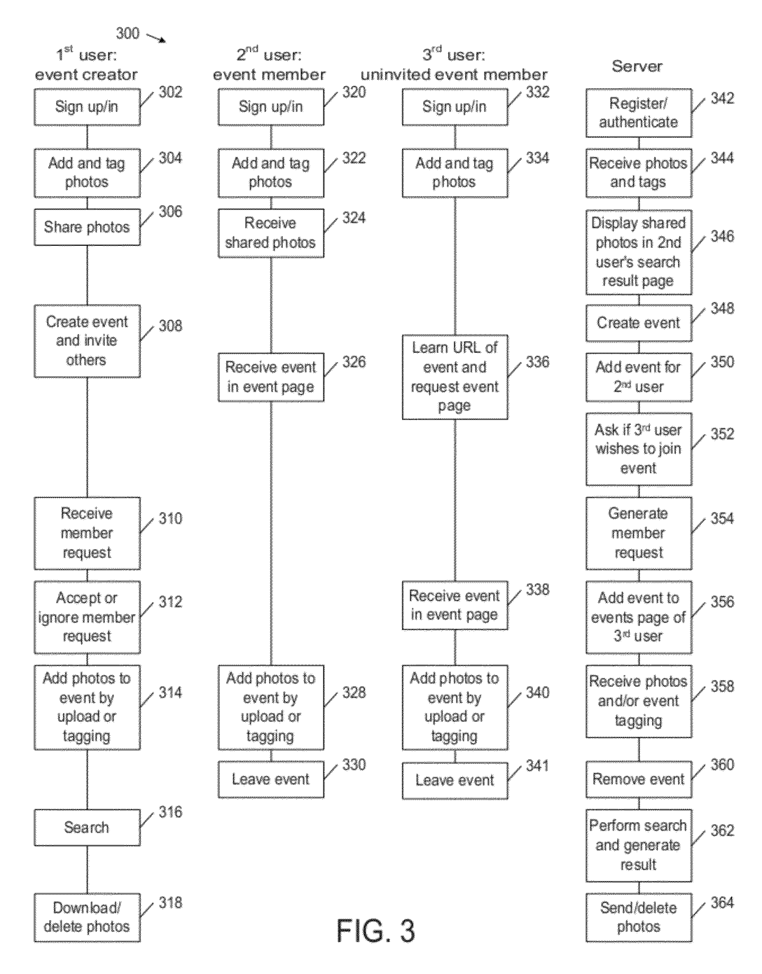

FIG. 3 is a flowchart of a method 300 implemented by system 10 (FIG. 1) for sharing photos in one or more embodiments of the present disclosure. To demonstrate the features of system 10, method 300 illustrates exemplary interactions among three users on client devices and server 12 (FIG. 1). Method 300, and other methods described in the present disclosure, may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation.

A first user of a first client device (e.g., user 16A of client device 16) performs blocks 302 to 318. In block 302, the first user signs up for or signs in with the media sharing service provided by server 12. Block 302 may be followed by block 304.

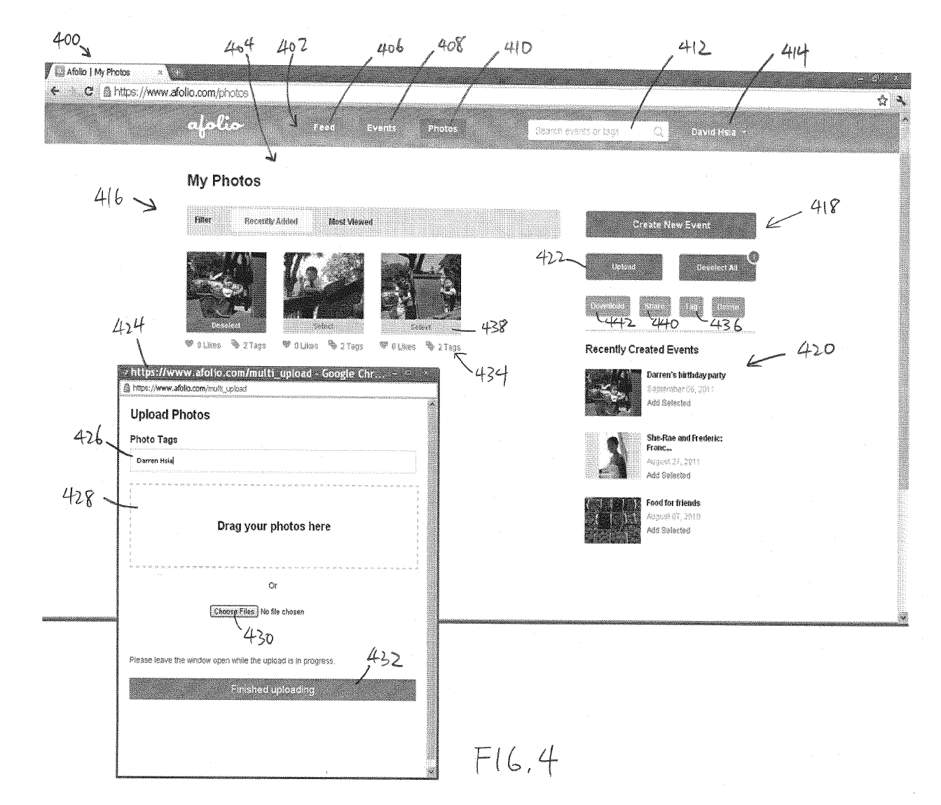

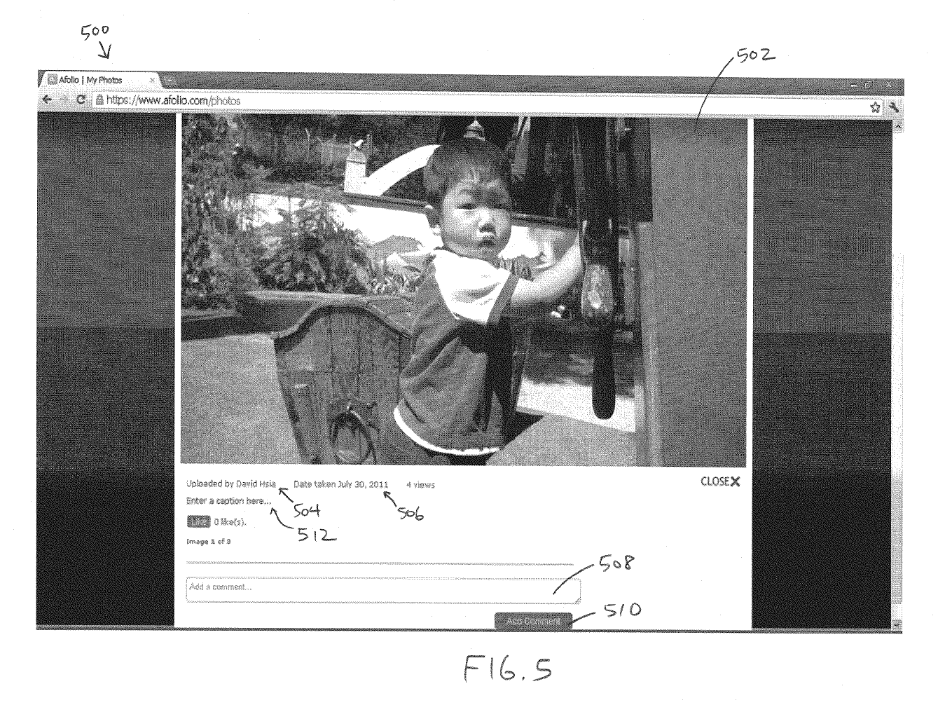

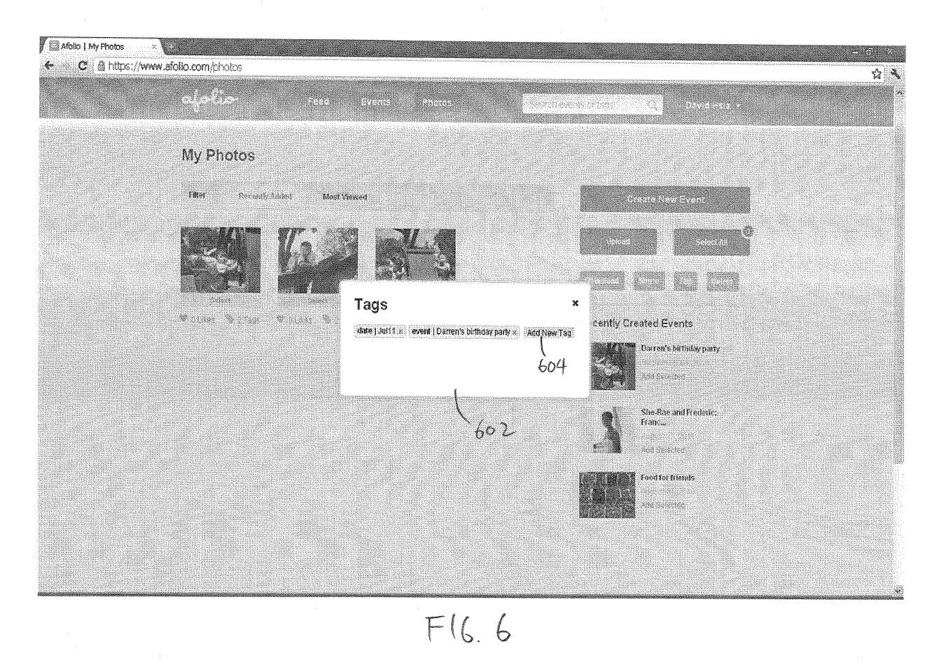

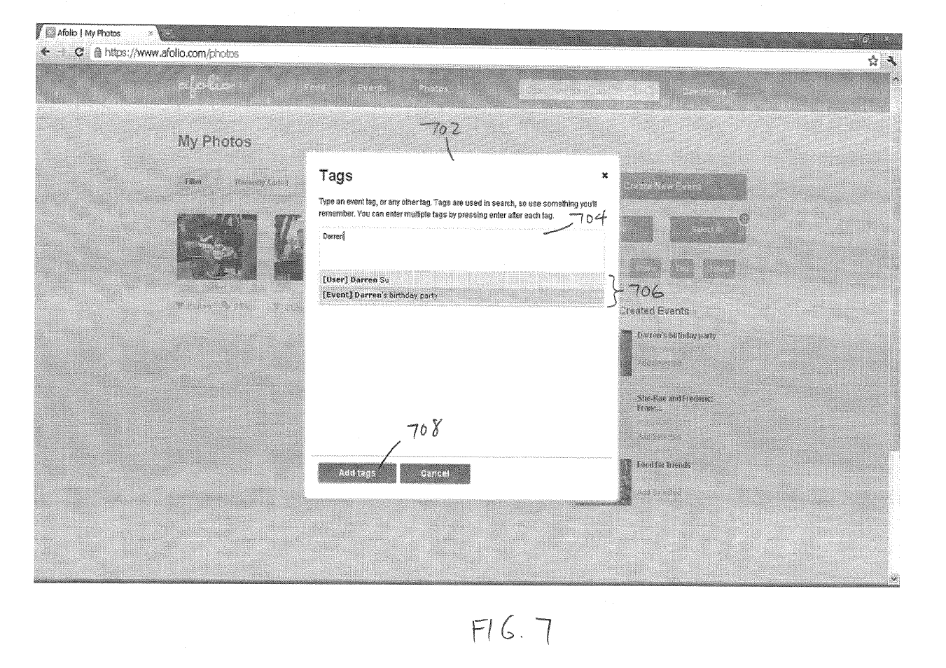

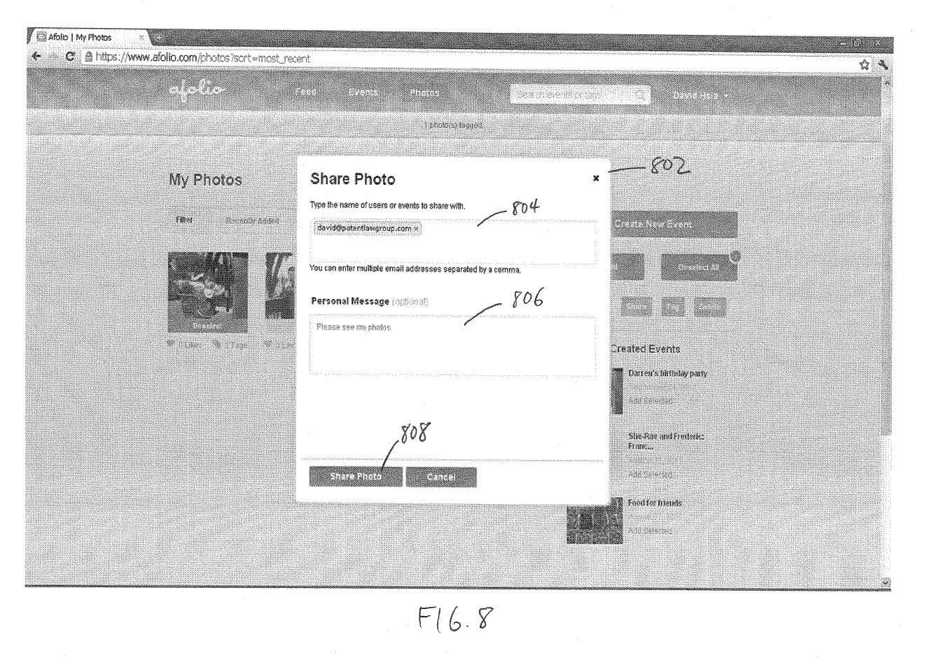

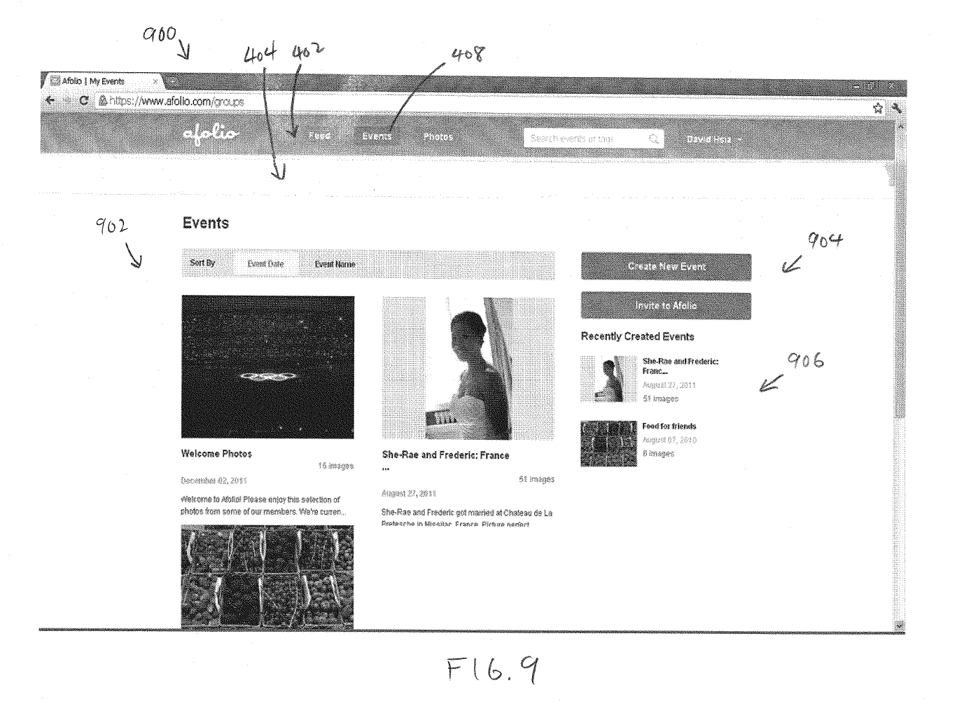

In block 304, the first user may add photos and tag them. FIG. 4 shows a photos webpage 400 presented by server 12 in one or more embodiments of the present disclosure. Photos webpage 400 is displayed by a browser application on client device 16 (FIG. 1). A similar UI with some or all the functionalities of photos webpage 400 may be generated by a desktop client application on client device 16 or a mobile client application on a mobile device.

Photos webpage 400 includes a menu 402 above a main viewing area 404. Menu 402 includes a “Feed” button 406, an “Events” button 408, a “Photos” button 410, a search field 412, and a user drop down menu 414. The first user arrives at photos webpage 400 by selecting Photos button 410 in menu 402 from another webpage. Main viewing area 404 displays a “Photos” view including a “My Photos” area 416, a tools area 418, and a “Recently Created Events” area 420. Tools area 418 includes an upload button 422 for uploading photos to server 12 (FIG. 1). My Photos area 416 includes all the photos in the first user's library on system 10. When the first user selects upload button 422, server 12 generates an upload webpage 424 for uploading photos. Upload webpage 424 includes a “Photo Tags” box 426, a drag and drop area 428, a “Choose Files” button 430, and a “Finished uploading” button 432. The first user may upload photos to her library by placing them in drag and drop area 428 or selecting them using a file explorer activated by Choose Files button 430. In Photo Tags box 426, the first user may enter common tags to be applied to all the uploaded photos or different tags for each photo that is uploaded. Existing tags may appear as suggestions below Photo Tags box 426 as the first user enters a tag name. After the photos are uploaded, the first user clicks the Finished uploading button 432 to return back to My Photos area 416 to view the newly uploaded photos. The new photos and their tags are sent to server 12 for storage in database 12A and inclusion in the first user's library.

Once photos are uploaded, thumbnails of the photos in the first user's library are displayed in My Photos area 416. The photos in My Photos area 416 are uploaded by the first user. The photos in My Photos area 416 may be sorted by photo filters listed at the top of the photos area, such as “Recently Added,” “Most Viewed,” and “Date Taken.” In response, server 12 updates photos webpage 400 based on the sort result. The first user may click or tap a photo for viewing. In response, server 12 generates a photo webpage 500 as shown in FIG. 5 in one or more embodiments of the present disclosure. Photo webpage 500 displays a photo 502, a user name 504 of the user that uploaded the photo, a taken date 506, a comment box 508, and an add comment button 510. As the first user is the owner of photo 502, server 12 provides a caption box 512 for the first user to enter a caption. Any shared with user may provide comments on photo 502.

Referring back to FIG. 4, under each thumbnail is a “Tags” link 434 (only one is labeled). When Tags link 434 is selected, server 12 generates a Tags dialog box 602 as shown in FIG. 6 in one or more embodiments of the present disclosure. Tags dialog box 602 displays the tags for a corresponding photo and allows the first user to delete any tag by selecting its “x” icon and add one or more tags by selecting an “Add New Tag” button 604. The user can also click any event tag to go directly to the event webpage, or on any tag to do a search on that tag. When “Add New Tag” button 604 is selected, server 12 generates another tags dialog box 702 as shown in FIG. 7 in one or more embodiments of the present disclosure. Tags dialog box 702 is also generated when the first user selects one or more photos in photos area 434 (FIG. 4) and then clicks a “Tag” button 436 (FIG. 4). The first user is able to select and deselect one or more photos by selecting the corresponding “Select/Deselect” cycle buttons 438 (only one is labeled in FIG. 4) under the thumbnails in My Photos area 416 and apply the same action to the photos at the same time. Tag dialog box 702 includes a tags box 704 for entering tags, a tag suggestion area 706, and an “Add tags” button 708. The first user may enter one or more tags in tags box 704. Existing tags appear as suggestions in tag suggestion area 706 as the first user enters a tag name.

In one or more embodiments of the present disclosure, server 12 automatically generates contextual tags for the photos based on information available to the server. In one or more embodiments of the present disclosure, server 12 uses the paths to the photos on client device 16 to suggest or create contextual tags for the photo. In one or more embodiments of the present disclosure, server 12 uses calendar and location data from client device 16 and/or third party servers 24 (FIG. 1) to suggest or create contextual tags for the photos. Server 12 may prepopulate Photos Tags box 426 (FIG. 4) and Tags dialog boxes 602, 702 (FIGS. 6 and 7) with the contextual tags or suggest them below the tag boxes 426 and 704 (FIGS. 4 and 7). These embodiments are described later in more detail.

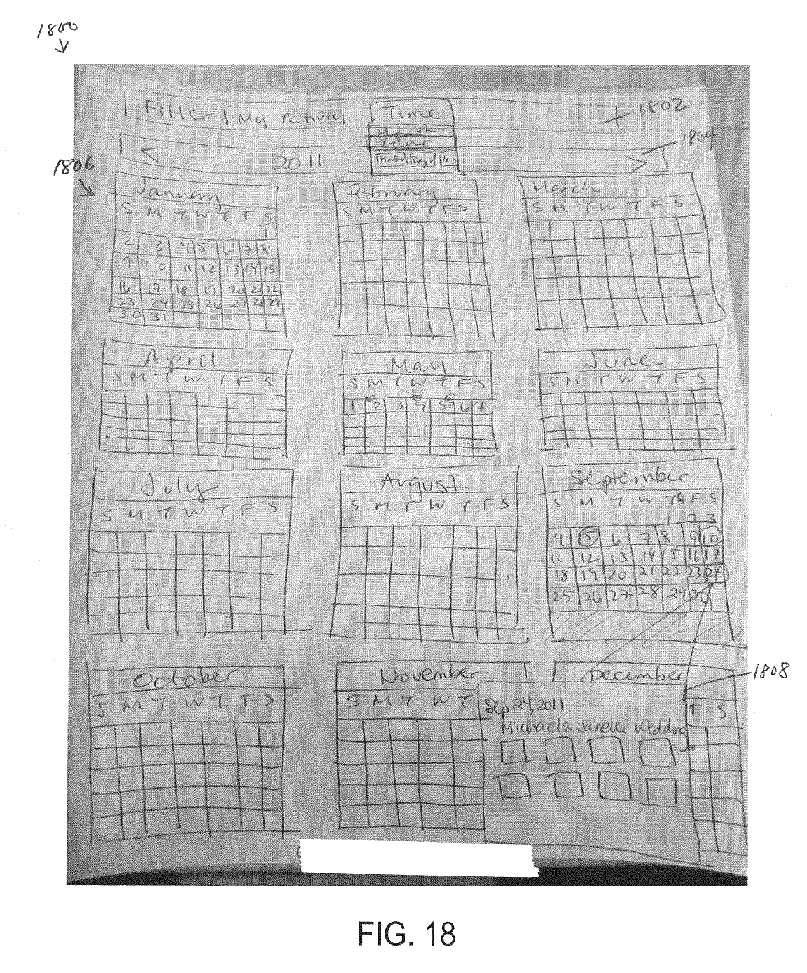

In one or more embodiments of the present disclosure, server 12 allows a photo to be tagged with audio. In one or more embodiments of the present disclosure, server 12 may provide a time-based view 1800 (FIG. 18) in My Photos area 416 (FIG. 4) that organizes the photos with a calendar-like UI. In one or more embodiments, server 12 may provide continuous playback of the photos in a slideshow with coordinated and supplemental audio from a third party application on client device 16. These embodiments are described later in more detail.

Referring back to FIG. 3, block 304 may be followed by block 306.

In block 306, the first user may share photos with a second user on a second client device (e.g., user 20A on client device 20). To share photos, the first user selects one or more photos in My Photos area 416 (FIG. 4) and a share button 440 (FIG. 4). In response, server 12 generates a dialog box 802 as shown in FIG. 8 in one or more embodiments of the present disclosure. Dialog box 802 includes a shared with box 804, a “Personal Message” box 806, and a “Share Photo” button 808. The first user may enter one or more users and events in shared with box 804. Server 12 sends emails with the personal message to the shared with users or shared with event members to inform them of the newly shared photos. To share with someone who is not a registered user of system 10, the first user enters that person's email in shared with box 804 and server 12 generates an invitation email to that person to join the photo sharing service and view the shared photos. Alternatively, the first user clicks Share button 440 to cause server 12 to post a URL of an event webpage (described later) with the selected photos to a third party website like Facebook and Twitter.

Referring back to FIG. 3, block 306 may be followed by block 308.

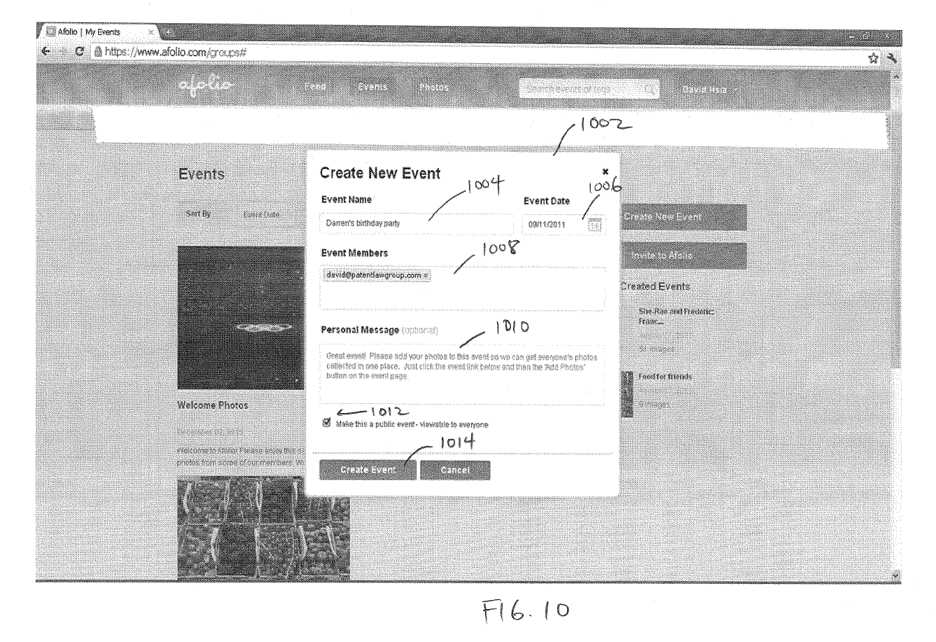

In block 308, the first user creates a new event and adds others to the event to share photos related to the event. FIG. 9 shows an events webpage 900 in one or more embodiments of the present disclosure. Events webpage 900 includes menu 402 above main viewing area 404. The first user arrives at events webpage 900 by default after signing in or by selecting Events button 408 from another webpage. Main viewing area 404 displays an “Events” view including “Events” area 902, a “Create New Event” button 904, and “Recently Created Events” area 906. Events in Events area 902 may be sorted by event filters listed at the top of the Events area, such as “Event Date” and “Event Name.” When the first user selects Create New Event button 904, server 12 generates a dialog box 1002 as shown in FIG. 10 in one or more embodiments of the present disclosure. Dialog box 1002 includes an “Event Name” field 1004, an “Event Date” picker 1006, an “Event Members” box 1008, a “Personal Message” box 1010, a public event check box 1012, and a “Create Event” button 1014. The event name provided by the user in Event Name field 1004 is used by server 12 as the tag name of an event tag for the event. By selecting public event check box 1012, the event becomes viewable to any user that has the event URL. Otherwise, the event is only viewable by the members of the event.

The first user may enter one or more users in Events Members box 1008. To share with someone who is not a registered user of system 10, the first user enters that person's email in Events Member box 1008 and server 12 generates an invitation email to that person to join the photo sharing service and the event. In one or more embodiments of the present disclosure, the first user may use client application 17 (desktop or mobile) to create and display a dynamic event invitation to join the event in the form of an optical code, such as a Quick Response (QR) code. Another user captures the invitation with the camera on her mobile device and uses the invitation to access the event. This embodiment is described in more detail later.

Referring back to FIG. 3, block 308 may be followed by block 310.

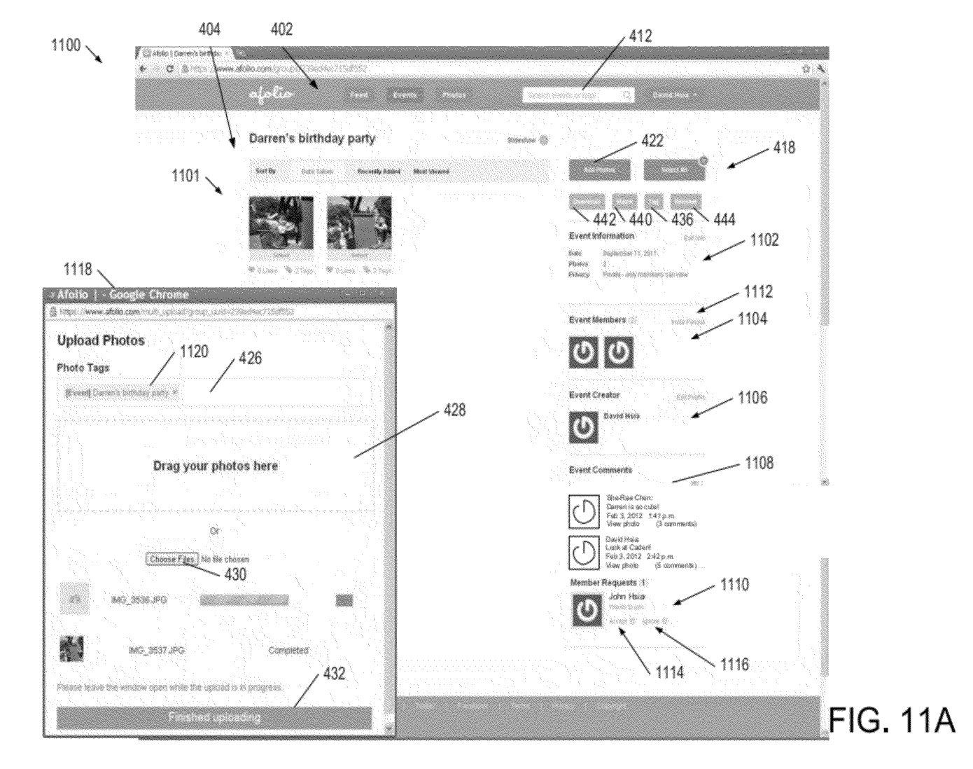

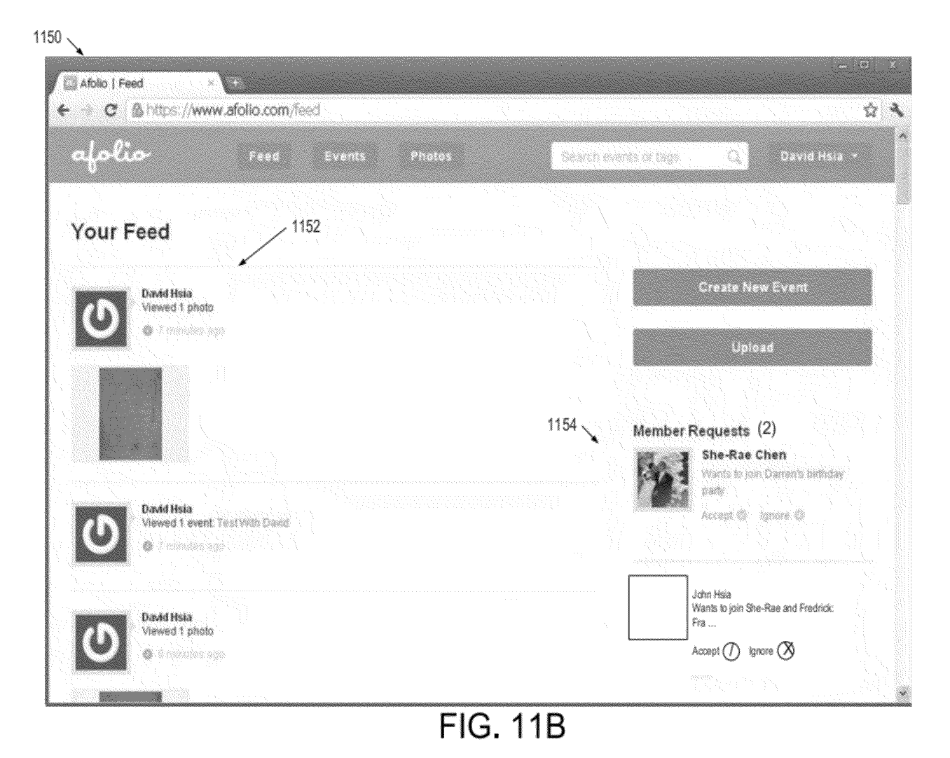

In block 310, the first user receives a member request from another user to join the event. FIG. 11A shows an event webpage 1100 in one or more embodiments of the present disclosure. Server 12 generates event webpage 1100 after the first user creates the event using dialog box 1002 (FIG. 10). Event webpage 1100 is substantially the same for all event members except the first user as the event creator may access additional functions. Event webpage 1100 includes menu 402 above main viewing area 404. Main viewing area 404 displays an “event” view including an event photos area 1101, tools area 418, an “Event Information” area 1102, an “Event Members” area 1104, an “Event Creator” area 1106, and an “Event Comments” box 1108. Event Comments box 1108 allows the first user to enter general comments about the event, which are displayed below the Event Comments box after the first user selects the “Add comment” button. Furthermore, a summary of the most recent comments from each photo with one or more comments may appear below the Event Comments box 1108. By clicking a View Photo link on a photo comment, server 12 generates a photo webpage 500 (FIG. 5) of the corresponding photo.

The event view also includes a “Member Requests” area 1110 for the first user. Event photos area 1101 displays thumbnails of photos that are uploaded to the event or uploaded elsewhere (another event or a user) but tagged with the corresponding event tag. Tools area 418 includes the previously described buttons for uploading, tagging, and sharing the photos in event photos area 1101. The functionalities of tools area 418 are described above and not repeated. Event information area 1102 includes an event date, a number of photos in the event, and a privacy setting for the event (private or public). Event information area 1102 may be edited by the first user as she is the event creator.

Event Members area 1104 includes thumbnails of users that are event members and an “Invite People” link 1112 to invite others to join the event. When Invite People link 1112 is selected, server 12 generates a dialog box 1202 as shown in FIG. 12 in one or more embodiments of the present disclosure. Dialog box 1202 includes an invitees box 1204, a “Personal Message” box 1206, and an “Invite to Event” button 1208. The first user may enter one or more users in invite box 1204. To share with someone who is not a registered user of system 10, the first user enters that person's email in invitees box 1204 and server 12 generates an invitation email to that person to join the photo sharing service and the event.

Event Creator area 1106 includes thumbnail of the user that created the event. Event Creator area 1106 may be edited by the first user as she is the event creator.

Referring back to FIG. 11A, Member Requests area 1110 includes one or more thumbnails of users who wish to become members of the event, an “Accept” button 1114, and an “Ignore” button 1116. The member request may also show up in a Feed page 1150 in a Member Request summary section as shown in FIG. 11B in one or more embodiments of the present disclosure. Feed page 1150 includes a feed area 1152 that lists the first user's activities, such as the photos added and viewed. Feed page 1150 includes a Member Request area 1154 that provides all member requests to events created by the first user. Member Request area 1154 provides a central place where the first user can quickly accept member requests to multiple events.

Referring back to FIG. 3, block 310 may be followed by block 312.

In block 312, the first user accepts or ignores the member request from, for example, a third user on a third client device (such as user 18A on client device 18) to join the event. Block 312 may be followed by block 314.

In block 314, the first user adds photos to the event by uploading the photos from the local device to the event or by tagging existing photos in her library with the event tag. Referring to FIG. 11A, when the first user selects Add Photos button 422, server 12 generates a webpage 1118 for uploading photos. Webpage 1118 includes Photo Tags box 426, drag and drop area 428, Choose Files button 430, and Finished Uploading button 432. Server 12 prepopulates Photos Tag box 426 with the event tag 1120 for the event. The first user selects Finished uploading button 432 to complete the upload of the photos and their tags to server 12 for storage in database 12A and inclusion in the event.

To add existing photos from the first user's library to the event, such as those uploaded in block 304, the first user tags them with the event tag using the tagging procedure described above for photos webpage 400 and dialog boxes 602, 702. Server 12 generates emails informing the event members of the newly shared photos in the event. Each email contains a URL link to event webpage 1100. Once the photos are uploaded, thumbnails of the photos are displayed in event photos area 1101 in event webpage 1100, which is visible to all event members.

As introduced above, server 12 may automatically generate contextual tags for the photos based on information available to the server and prepopulate tag boxes with the contextual tags or suggest the contextual tags below the tag boxes. As introduced above, server 12 may allow a photo to be tagged with audio. As introduced above, server 12 may provide continuous playback of the photos with coordinated and supplemental audio from a third party application on client device 16. These embodiments are described later in more detail.

In one or more embodiments of the present disclosure, server 12 may provide a visual representation of the event created from different perspectives based on photos of the event from different event members. This embodiment is described later in more detail.

Referring back to FIG. 3, block 314 may be followed by block 316.

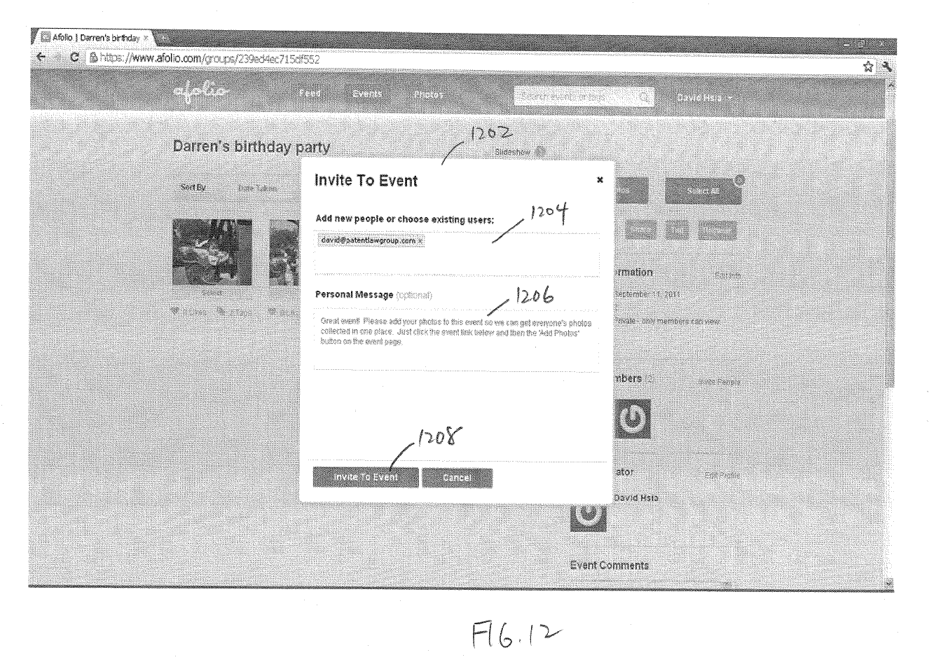

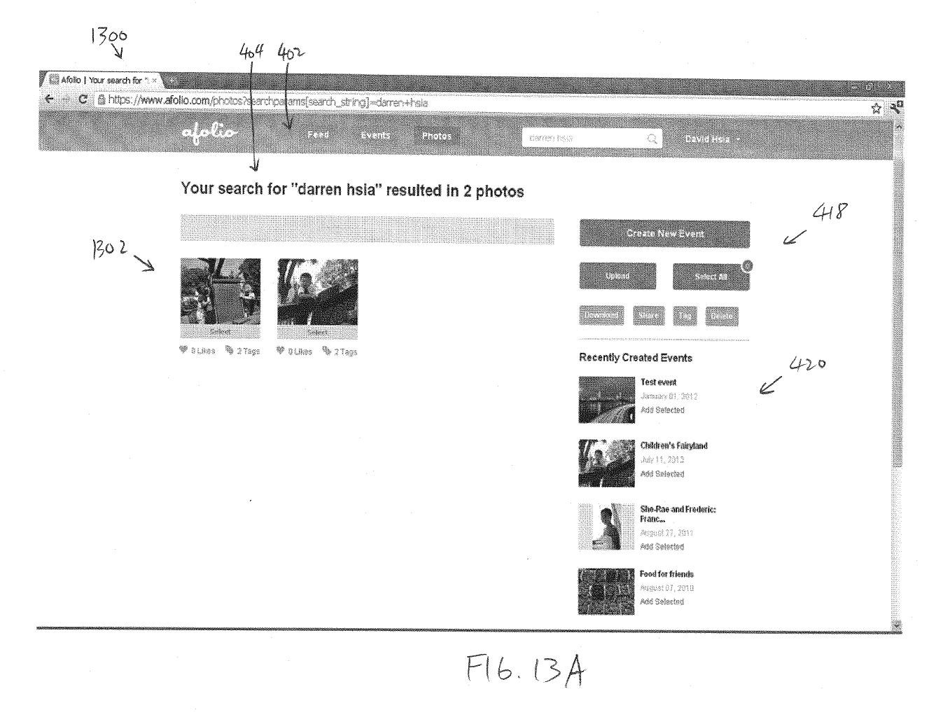

In block 316, the first user may search for photos by their tags and events. Referring back to FIG. 4 or 11, the first user may enter one or more search terms in search field 412 in menu 402. Server 12 performs a look up and returns photos with tags matching the search terms. FIG. 13A shows a search result webpage 1300 in one or more embodiments of the present disclosure. Search result webpage 1300 includes menu 402 above main viewing area 404. Main viewing area 404 displays a “search result” view including search result area 1302, tools area 418, and Recently Created Events 420. Search result area 1302 displays thumbnails of photos with tags that match the search terms provided by the first user. Tools area 418 includes the previously described buttons for uploading, tagging, and sharing the photos in search result area 1302. The photos in result area 1302 can also be added to an event in the Recently Created Events area 420 by selecting their thumbnails and then clicking the “Add Selected” link next to the event. In response, server 12 adds the corresponding event tag to the selected photos. The functionalities of tools area 418 are described above and not repeated.

Referring back to FIG. 3, block 316 may be followed by block 318.

In block 318, the first user may download or delete photos from her library or an event. As described above, the first user is able to select and deselect one or more photos by clicking or tapping the corresponding select/deselect cycle buttons 438 (only one is labeled in FIG. 4) under the thumbnails of the photos in My Photos area 416 to download or delete the photos at the same time. When downloading multiple photos, server 12 may send them concurrently. When the number of photos exceeds a threshold, server 12 may zip the photos into a compressed file and send an email to the first user with a URL for downloading the compressed file.

The second user on the second client device (e.g., user 20A on mobile client device 20 with mobile client application 23) performs blocks 320 to 330. Mobile client application 23 provides comparable functionalities as the webpages provided by server 12 to the first user. In block 320, the second user signs up for or signs in with the media sharing service provided by server 12. Block 320 may be followed by block 322.

In block 322, the second user may add photos as described for the first user in block 304. Mobile client application 23 also allows the user to take photos with the built-in camera of mobile client device 20 and upload the photo to server 12. Block 322 may be followed by block 324.

In block 324, the second user receives the photos shared by the first user in block 306. As described above, the second user may receive an email informing her of the newly shared photos. In embodiments implementing the inbox concept, the shared photos appear in the second user's inbox and she may add them to her library. The shared photos may also appear in any search by the second user using search terms that match the tags of the shared photos. Block 324 may be followed by block 326.

In block 326, the second user receives the event shared by the first user in block 308. The event appears in the second user's events UI on mobile client application 23 (similar to Events area 902 in events webpage 900 of the first user in FIG. 9).

As described above, the second user may receive an email informing her of the newly shared event with a URL. The second user can forward the email with the URL to the third user. When the third user clicks on the URL to access event webpage 1100, server 12 determines that the third user is not an event member and generates a member request to join the event from the third user to the first user. Block 326 may be followed by block 328.

In block 328, the second user may add photos to the event by taking new photos, uploading photos from the local device to the event, or by tagging existing photos with the event tag. FIG. 13B is a screenshot of a UI 1350 generated by mobile client application 23 (FIG. 1) after the second user selects an event in one or more embodiments of the present disclosure. UI 1350 includes a “+” button to add one or more photos to the event. When the second user selects the + button, mobile client application 23 presents a UI 1352 with a “Take New Photo” button, an “Add from Library” button, and a “Invite to Event” button. When the second user selects the Take New Photo button, mobile client application 23 presents a UI for taking a photo and uploading the photo to server 12 to include in the event. When the second user selects the Add from Library button, mobile client application 23 presents a UI for uploading existing photos on mobile device 20 to server 12 to include in the event. Mobile client application 23 automatically tags the uploaded photos with the corresponding event tag. When the second user selects the Invite to Event button, mobile client application 23 presents a UI for the second user to enter emails of the invitees to the event. As described above, server 12 may send emails to inform the event members of the newly shared photos. Block 328 may be followed by block 330.

In block 330, the second user may leave the event. In other word, the second user may delete the event from the second user's Events area 902 (FIG. 9).

The third user on the third client device (e.g., user 18A on desktop client device 18) performs blocks 332 to 341. In block 332, the third user may sign up for or sign in to the media sharing service provided by server 12. Block 332 may be followed by block 334.

In block 334, the third user may add and tag photos as described for the first user in block 304. Block 334 may be followed by block 336.

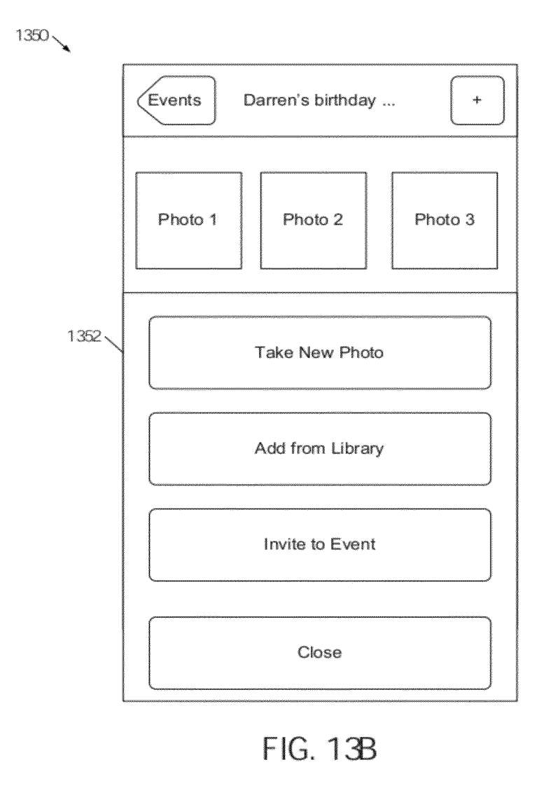

In block 336, the third user may learn of the URL for event webpage 1100 (FIG. 11A) from the second user and click on the URL to request the event webpage. In response, server 12 determines that the third user is not an event member and generates a webpage 1400 as shown in FIG. 14 in one or more embodiments of the present disclosure. Webpage 1400 informs the third user that she does not have permission to view the event. Webpage 1400 includes a “Request to join this event” button 1402. When “Request to join this event” button 1402 is selected, server 12 generates a dialog box 1404 that asks the third user to confirm she wishes to join the event. When confirmed, server 12 generates a member request from the third user to the first user to join the event that appears in the first user's Member Requests area 1110 (FIG. 11A) of her event webpage 1100 (FIG. 11A).

Referring back to FIG. 3, block 336 may be followed by block 338.

In block 338, assuming the first user accepts the member request from the third user, the event appears in the third user's Events area of her events webpage (similar to Events area 902 of events webpage 900 of the first user in FIG. 9). As described above, the third user may receive an email informing her of the newly shared event with the URL, which she can select to view event webpage 1100. Block 338 may be followed by block 340.

In block 340, the third user may add photos to the event by uploading the photos to the event or by tagging existing photos with the event tag as described for the first user in block 314. As described above, server 12 may send emails to inform the event members of the newly shared photos. The third user may also search for photos using their tags, download photos in a batch process, and delete photos in a batch process as described for the first user in blocks 316 and 318. Block 340 may be followed by block 341.

In block 341, the third user may leave the event. In other word, the third user may delete the event from the third user's Events area 902 (FIG. 9).

Server 12 performs blocks 342 to 364. In block 342, server 12 registers or authenticates the first, the second, and the third users. For a new user, server 12 creates a user table 26 (FIG. 2). Block 342 may be followed by block 344.

In block 344, server 12 receives uploads of photos and their tags. For each photo, server 12 creates a file table 28 (FIG. 2) and a photo shares table 25 (FIG. 2). For each tag for a photo, server 12 creates a tag table 30 (FIG. 2). Block 344 may be followed by block 346.

In block 346, server 12 receives the request from the first user to share photos with the second user. For each shared with user, server 12 creates a photo shares table 25 (FIG. 2). [Inbox?] Later when the second user performs a search for photos, server 12 looks up tags of the photos in the second user's library and any photos shared with the second user, such as those photos shared by the first user with the second user. Block 346 may be followed by block 348.

In block 348, server 12 receives the request to create the event from the first user and creates the event by generating an events table 34A identifying an event ID, the event name (i.e., event tag), and the event creator (“Owner”). For each event member, server 12 creates an event memberships table 34B identifying the event ID and a user ID.

To generate events webpage 1100 (FIG. 11A) for the event members, server 12 looks up tag tables 30 (FIG. 2) having the event tag and includes thumbnails of the corresponding photos in event photos area 1101 (FIG. 11A). From event memberships table 34B (FIG. 2) having the event ID and the pending flags set to “no,” server 12 includes thumbnails of the corresponding users in Event Members area 1104 (FIG. 11A) in event webpage 1100. Server 12 determines the event creator from events table 34B (FIG. 2) and includes a thumbnail of the event creator in Event Creator area 1106 (FIG. 11A) in event webpage 1100. From event memberships tables 34B having the event ID and the Pending flags set to “yes,” server 12 includes thumbnails of the corresponding users in Member Request area 1110 (FIG. 11A) in event webpage 1100. Block 348 may be followed by block 350.

In block 350, server 12 adds the event to the second user's Events area in her events webpage (similar to Events area 902 in events webpage 900 of the first user in FIG. 9). Server 12 looks up event membership tables 34B (FIG. 2) listing the second user as an event member and includes the corresponding events in the second user's Events area in her events webpage. When the second user selects the event, server 12 generates event webpage 1100 (FIG. 11A) for the second user. Block 350 may be followed by block 352.

In block 352, server 12 receives an HTTP request for event webpage 1100 (FIG. 11A) from the third user. Server 12 looks up event memberships tables 34B (FIG. 2) having the third user as an event member to determine if the third user is an event member to the event. When server 12 determines the third user is not an event member to the event, server 12 asks the third user if she wishes to join the event as shown in webpage 1400 (FIG. 14). Block 352 may be followed by block 354.

In block 354, assuming the third user confirms she wishes to join the event, server 12 generates an event memberships table 34B (FIG. 2) with a pending flag set to yes for the third user to join the event. Server 12 updates the first user's Membership Requests area 1110 (FIG. 11A) in event webpage 1100 (FIG. 11A) with the request from the third user to join the event. Block 354 may be followed by block 356.

In block 356, assuming the first user accepts the membership request from the third user, server 12 sets the pending flag to “no” from the third user's event membership table 34B for the event. Server 12 then adds the event to the third user's Events area 902 in her events webpage (similar to Events area 902 in events webpage 900 of the first user shown in FIG. 9) as described for the second user in block 350. Block 356 may be followed by block 358.

In block 358, in response to the first, the second, and the third user adding photos to the event, server 12 creates tag tables 30 (FIG. 2) for the event tag for these photos. As introduced above, server 12 may also create tag tables 30 for contextual tags for these photos. For newly uploaded photos, server 12 also creates file tables 28 (FIG. 2). In response to tag tables 30 with the event tag, server 12 adds the photos tagged with the event tag to event photos area 1101 (FIG. 11A) in event webpage 1100 (FIG. 11A). As described above, server 12 may generate emails to inform the event members of the newly shared photos. Block 358 may be followed by block 360.

In block 360, in response to the second user's request to leave the event in block 330, server 12 removes the event from the second user's Events area in her events webpage (similar to Events area 902 in events webpage 900 of the first user in FIG. 9) by deleting the corresponding event memberships table 34B (FIG. 2) for the second user to the event. Block 360 may be followed by block 362.

In block 362, in response to the first user's search request, server 12 searches tag tables 30 (FIG. 2) and return their corresponding photos to search result area 1302 (FIG.13) in search result webpage 1300 (FIG. 3). Block 362 may be followed by block 364.

In block 364, in response to the first user's download or delete request, server 12 transmits or deletes photos in a batch process.

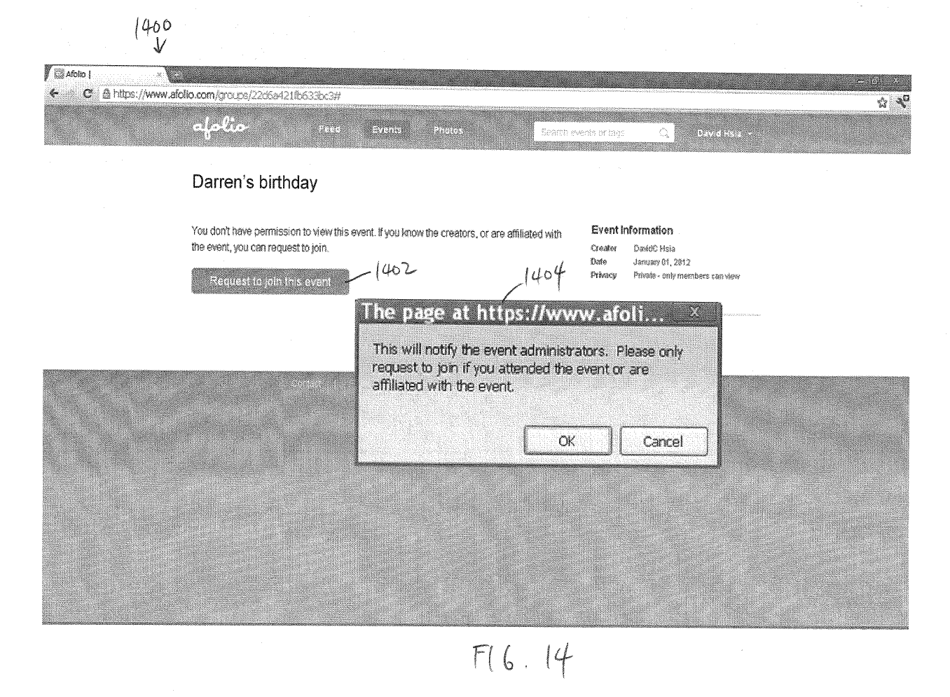

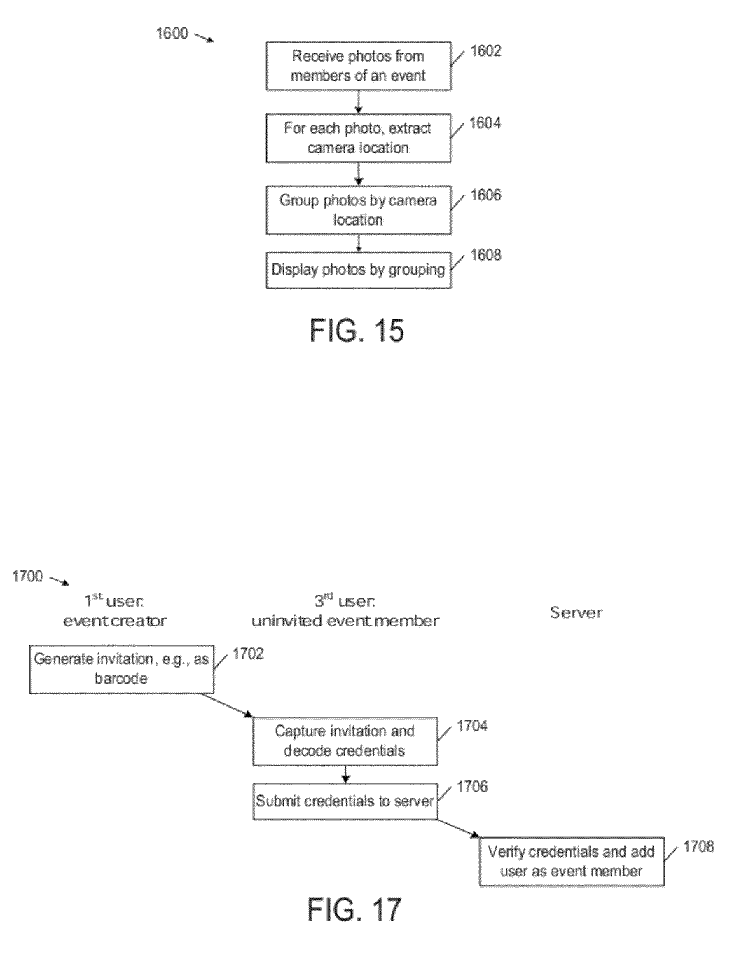

FIG. 15 is a flowchart of a method 1600 of server 12 to display the photos from an event to present the event from different perspectives in one or more embodiments of the present disclosure. In block 1602, server 12 receives photos added by event members for an event. Block 1602 may be followed by block 1604. In block 1604, for each photo, server 12 extracts the camera location when the photo was taken from the photo's EXIF data. Camera location is determined from the GPS coordinates recorded in the photo's EXIF data. Block 1604 may be followed by block 1606. In block 1606, server 12 groups the photos by their camera locations. Block 1606 may be followed by block 1608. In block 1608, server 12 generates an event webpage 1648 that visually represents the event from different perspectives as shown in FIG. 16 in one or more embodiments of the present disclosure. Event webpage 1648 includes a photos area 1650 arranged into geographical sections (e.g., quadrants) 1652, 1654, 1656, and 1658. Photos from the event are placed into the proper quadrants based on their GPS coordinates. This provides a way for the user to visually experience the event from different perspectives. Photos area 1650 also allows the user to manually place photos without GPS coordinates into a quadrant.

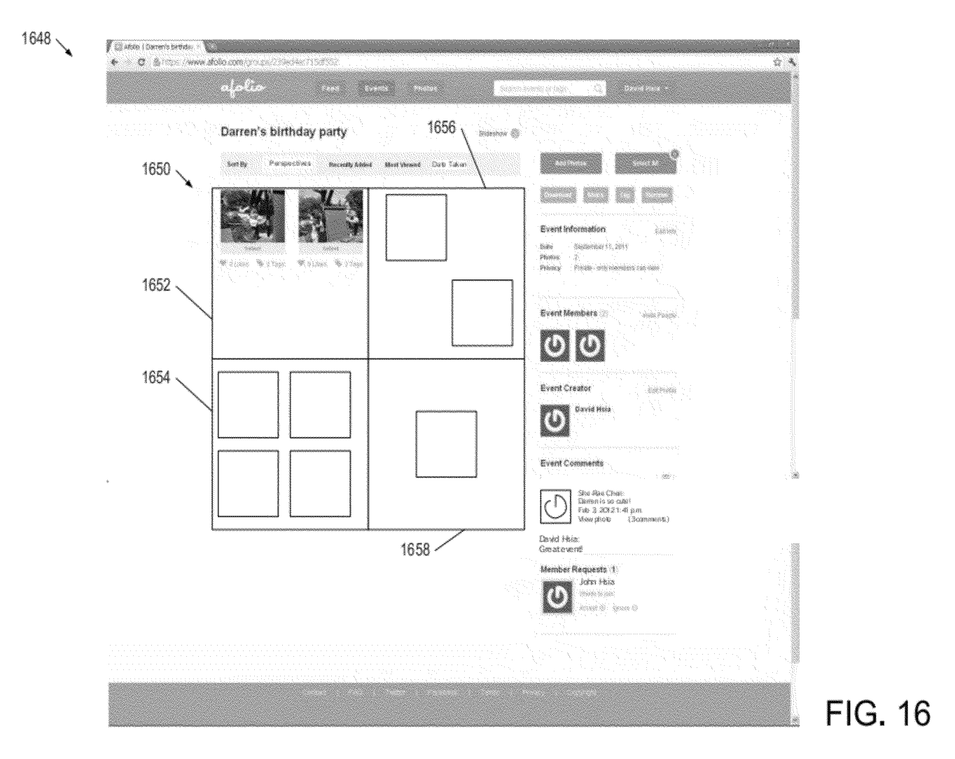

FIG. 17 is a flowchart of a method 1700 for a client application on a client device (e.g., mobile client application 23 on mobile client device 20 in FIG. 1) to generate an invitation to another client application on another client device (e.g., a mobile client application on mobile client device 22 in FIG. 1) to join an event in one or more embodiments of the present disclosure. In block 1702, user 20A (FIG. 1) causes mobile client application 23 to create and provide an invitation for an event. The invitation includes the necessary credentials that give the invitee access to the event. The invitation may be in the form of a machine readable barcode such as a QR code. Alternatively the invitation may be a message transmitted by near field communication, such as Bluetooth and RFID. Block 1702 may be followed by block 1704. In block 1704, user 22A (FIG. 1) uses the mobile client application on mobile client device 22 to receive the invitation. For example, user 22A uses the mobile client application to take a picture of the QR code and decode the credentials. Block 1704 may be followed by block 1706. In block 1706, the mobile client application on client device 22 submits the credentials to server 12. Block 1706 may be followed by block 1708. In block 1708, server 12 verifies the credentials and adds user 22A to the event so the user may access the corresponding event webpage.

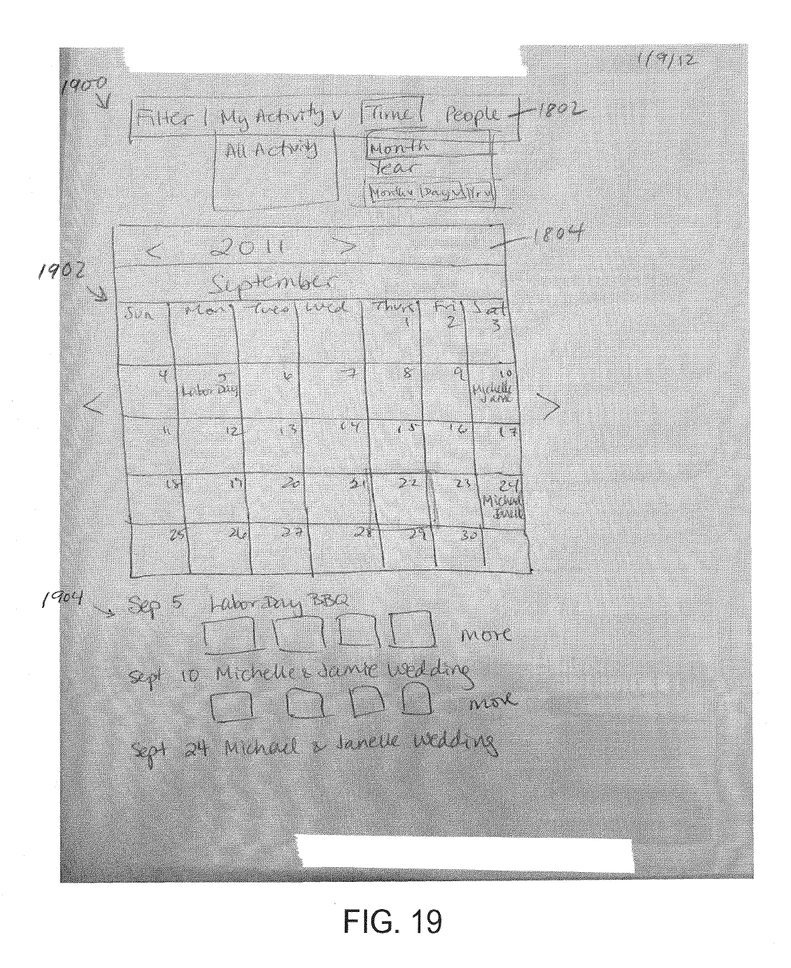

FIG. 18 illustrates a webpage 1800 presented by server 12 with a calendar-like UI for viewing a user's photos in one or more embodiments of the present disclosure. Webpage 1800 includes a filter menu 1802, a year menu 1804, and a yearly calendar 1806. Filter menu 1802 includes filters such as activity and time (e.g., month, year, and date). Activity refers to all activities or only the user's activities (e.g., Facebook News Feeds vs. My Profile). Year menu 1804 shows the year of displayed calendar and forward/backward buttons for viewing other years. Calendar 1806 includes the months where a date is visually indicated (e.g., highlighted or circled) when there are photos captured on that date. When the user hovers over a date, a window 1808 is generated with thumbnails of the photos from that date. The user may select a month to bring up a webpage 1900 in FIG. 19 generated by server 12 in one or more embodiments of the present disclosure. Webpage 1900 includes filter menu 1802, year menu 1804, a monthly calendar 1902, and a thumbnails area 1904. In monthly calendar 1902, event names are listed on the dates they occurred. In thumbnails area 1904, the thumbnails are separated into groups under their corresponding event dates and event names.

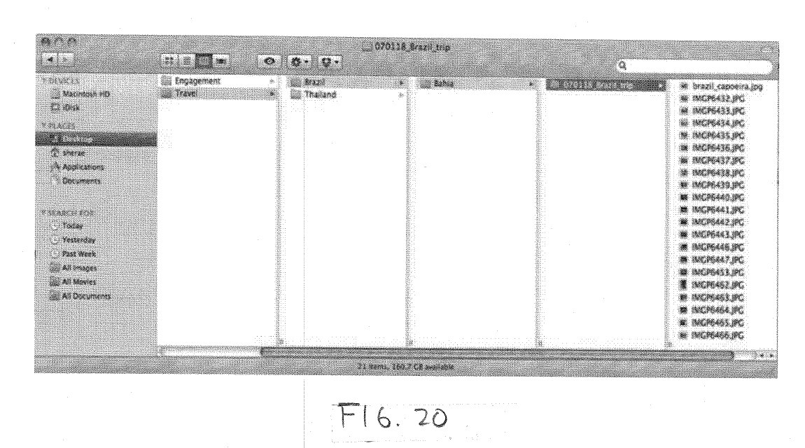

Instead of being a browser application for a web-based interface with server 12, a client application (e.g., client application 17 in FIG. 1) may be a desktop client application on a client device (e.g., client device 16 in FIG. 1) in one or more embodiments of the present disclosure. Desktop client application 17 creates various UIs and communicates with server 12 using the appropriate application programming interface (API). FIG. 20 illustrates an example of a user's desktop with media files (e.g., photos) the user wishes to share and organize. Desktop client application 17 copies the photos into a designated “Afolio” folder. Desktop client application 17 records components of the paths to the photos on client device 16 as initial tags for the photo. Desktop client application 17 may also record EXIF data of the photos as initial tags for the photos. Alternatively desktop client application 17 may provide the paths to server 12, which creates the initial tags from the path components and the EXIF data. A mobile client application (e.g., client application 23 in FIG. 1) may perform similar auto tagging functions on a mobile client device (e.g., client device 20 in FIG. 1).

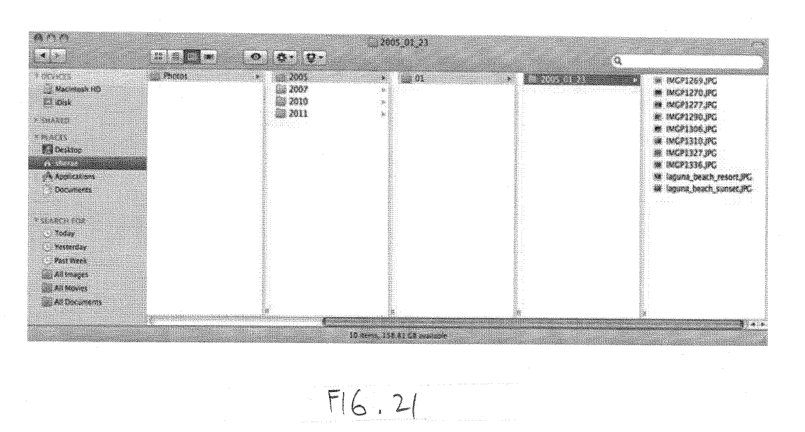

FIG. 21 illustrates the Afolio folder in one or more embodiments of the present disclosure. Desktop client application 17 (FIG. 1) automatically organizes the photos in the Afolio folder into date folders based on the dates the photos were taken. First user 16A uses desktop client software 17 to upload the photos and their initial tags, if any, to server 12. Mobile client application 23 (FIG. 1) may perform similar functions on mobile client device 20 (FIG. 1).

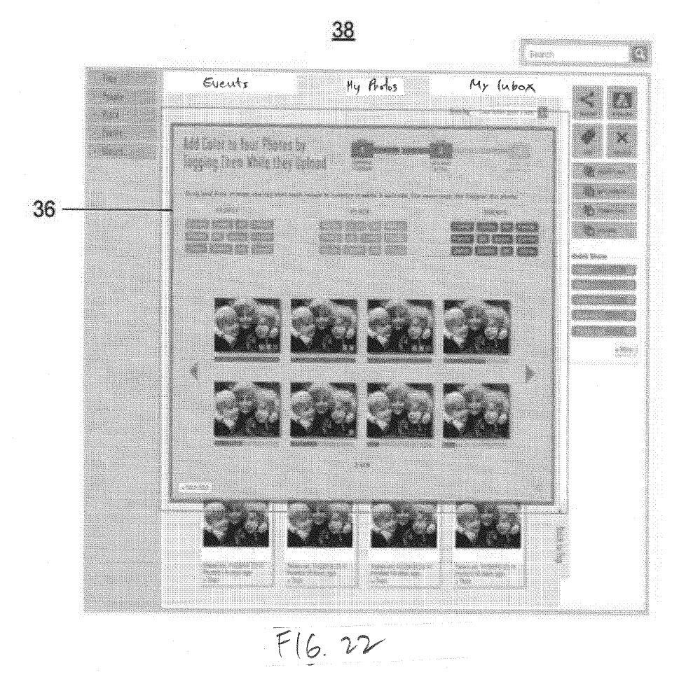

In one or more embodiments of the present disclosure, server 12 (FIG. 1) allows the user to tag the photos as a client application (e.g., a browser application 17 in FIG. 1) uploads the photos to server 12. FIG. 22 illustrates a webpage presented by server 12 to the user in one or more embodiments of the present disclosure. The webpage includes a main viewing area 38. In FIG. 22, a tagging while uploading window 36 is displayed. Tagging while uploading window 36 is where the user is able to drag and drop tags from a set of categorical tags (e.g. People, Place, Events) onto the photos being uploaded to tag them while browser application 17 uploads the full-size photos to server 12 in the background. The categorical tags are color-coded, so after at least one tag is applied to a photo, a small visual indicator will be displayed on the photo reflecting that tag. Then the user can at a glance see which photos have been tagged, and for which category. Instead of a browser application 17, a desktop client application may be used to provide the tagging while uploading function. A mobile client application (e.g., client application 23 in FIG. 1) may provide similar tagging while uploading functions on a mobile client device (e.g., client device 20 in FIG. 1).

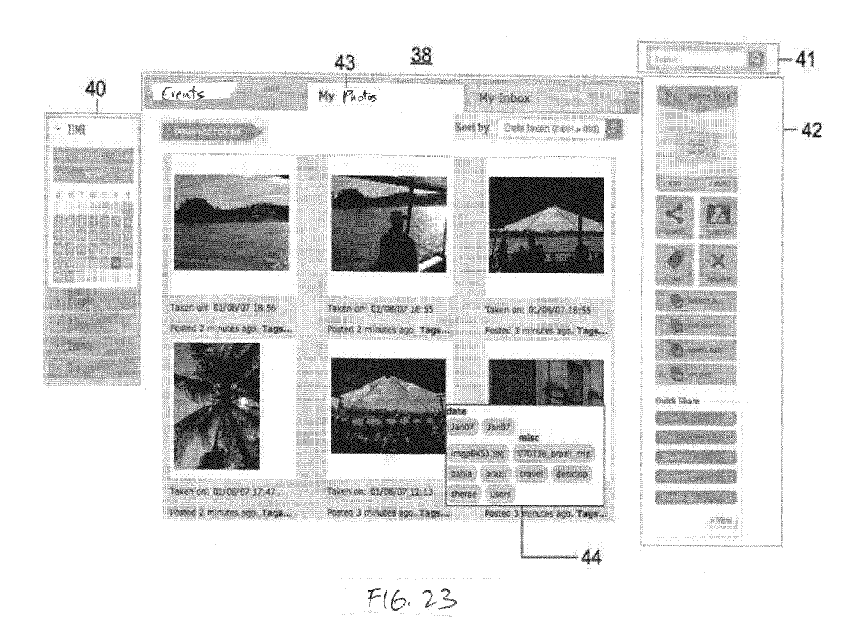

FIG. 23 illustrates a webpage presented by server 12 after the photos have been uploaded in one or more embodiments of the present disclosure. The webpage includes main viewing area 38, a searching and filtering area 40, and an action toolbar area 42. Main viewing area 38 can have multiple tabbed views. In FIG. 23, a “My Photos” view 43 is displayed. My Photos view 43 shows thumbnails of the user's library in database 12A (FIG. 1). Searching and filtering area 40 includes different parameters by which the user can filter the photos in My Photos view 43 by time, people, places, events, and groups. Groups refer to a distribution group of people, such as a group imported from third parties such as Google. In response to parameters set by the user, server 12 filters the photos using data structures 25 and then displays the result. A search box 41 is where the user can enter text to search the tags of the photos.

Action toolbar area 42 represents the different actions that the user can apply to one or more selected images in My Photos view 43. These actions include share, print, tag, delete, select all, download, upload, and quick share. Actions such as share, tag, upload, and print have subsequent dialog boxes for user input after their corresponding buttons are clicked. The quick share area allows for 1-click sharing with the people that the user shares most frequently with. At the top of action toolbar area 42 is a “Drag Images Here” area where users can drag and drop photos to collect several photos from different views that they want to select.

A pane 44 represents the tags associated with a selected photo. Server 12 (FIG. 1) may receive initial tags for a photo when the photo is uploaded, where the initial tags are generated by a desktop or a mobile client application using the folder path of the file on the client device. The initial tags are saved under miscellaneous (misc) category in tag table 30 (FIG. 2). These initial tags can be moved to their appropriate tag categories later on. For example, the initial tags in pane 44 are generated from the folder path of the selected photos in FIG. 20.

FIG. 24 illustrates how a user shares one or more images selected from My Photos view 43 with an individual user, multiple users, or members of an event in one or more embodiments of the present disclosure. In response to the user clicking the share button in action tool bar area 42, server 12 presents a dialog box 45 to the user. Dialog box 45 includes an area for the user to enter names of people to share with, as well as the option to create a new event (formerly referred to as a “Group” in the provisional application).

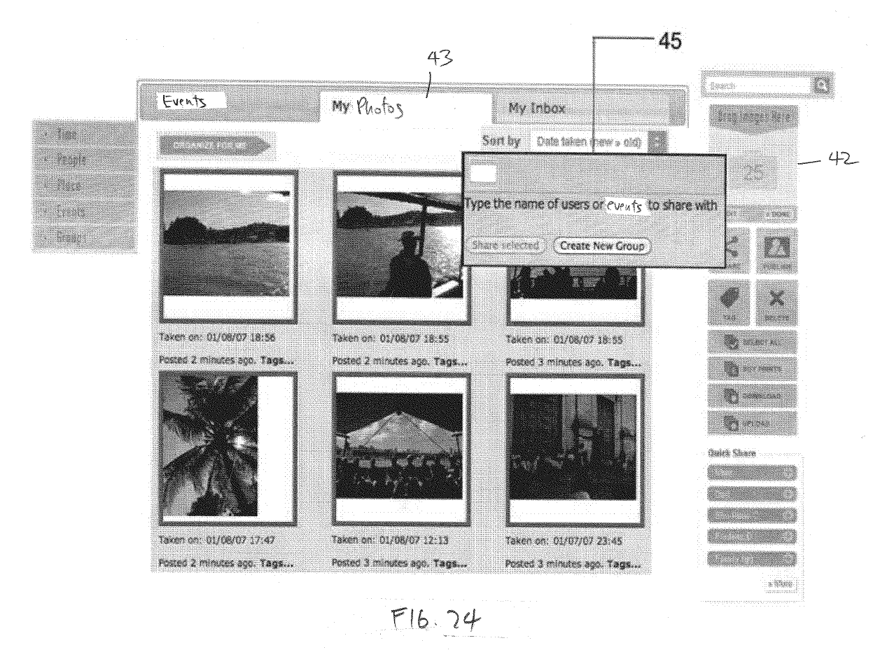

FIG. 25 illustrates how a user creates an event to share images in one or more embodiments of the present disclosure. Server 12 generates a dialog box 46 that allows the user to designate people the user wishes to add as members of the event and have access to an event tag of the event. For example, dialog box 46 displays an event tag named “Brazil,” and the selected event members are “Jasmine” and “Richard.” In response to the user selecting “Ok,” server 12 sends an invitation to all the new event members.

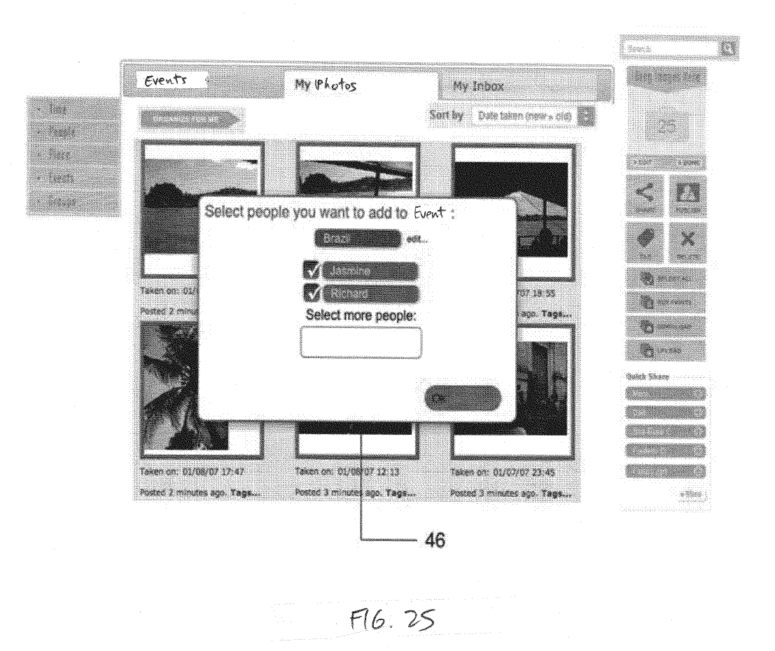

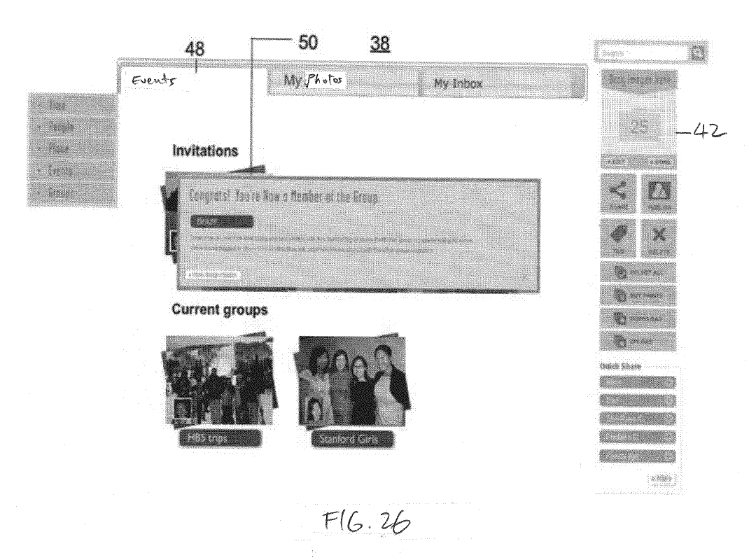

FIG. 26 illustrates an “Events” view 48 in main viewing area 38 in one or more embodiments of the present disclosure. Events view 48 is where the user manages the user's event activities. Events view 48 includes invitations from other users to join an event and events the user created and joined. When the user clicks on one of the events that she is a member of, server 12 displays thumbnails of all the photos that members of the event have shared within “Events” view 48. In response to the user clicking an event invitation from another user, server 12 generates a dialog box 50 that informs the user she has been added to the event and server 12 adds the event to “Events” view 48. Server 12 automatically includes the event tag of the event as one of the available tags when the user selects the tag button or the share button in action toolbar area 42 to tag and share photos. In response to the user tagging one or more selected photos with the event tag in “My Photos” view 43 (FIG. 23), server 12 automatically shares the photos with other members of the event by adding the photos to Events view 48. Server 12 may automatically generate an email notification to the event members when photos are added to Events view 48.

In one or more embodiments of the present disclosure, server 12 automatically generates contextual tags for the photos based on information available to the server. Server 12 receives the path to each uploaded photo on a client device (e.g., client device 16 in FIG. 1) from a client application (e.g., browser or desktop client application 17 in FIG. 1) and records one or more of the path components (e.g., directory and file names) as one or more initial tags for the photo. Server 12 may also record one or more fields in the EXIF data of the photo (e.g., date and time the photo was taken and GPS coordinates) as one or more initial tags for the photo. Server 12 may convert the GPS coordinates to a geographic location and record the location as a tag instead of the GPS coordinates. Alternatively client application 17 may generate these initial tags and provide them to server 12 along with the photo.

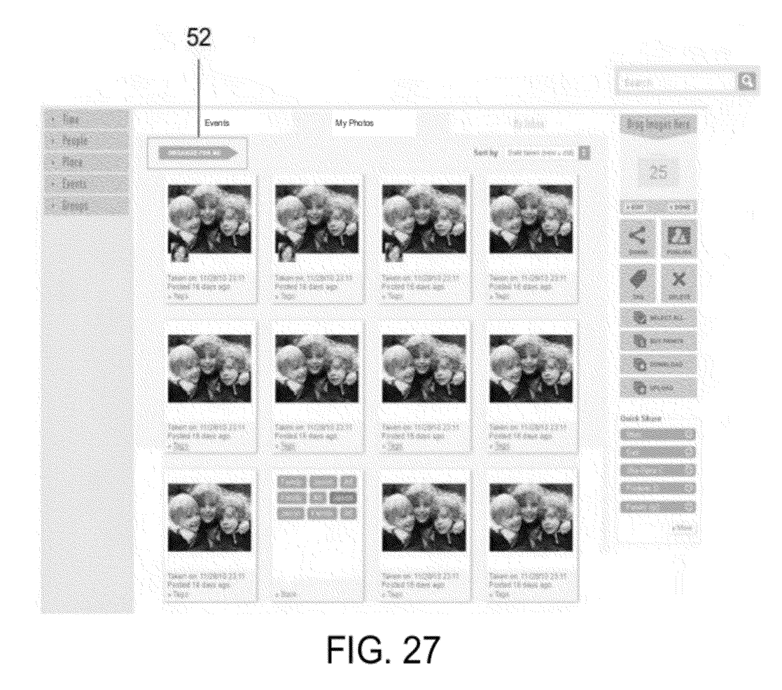

In one or more embodiments of the present disclosure, server 12 uses calendar and location data from a client device (e.g., client device 16 in FIG. 1 such as Outlook calendar) and/or a third party server (e.g., third party server 24 in FIG. 1 such as Google calendar, Facebook events, etc.) to prepopulate or suggest tags for uploaded photos. FIG. 27 illustrates how server 12 uses calendar and location data from one or more third party online servers 24 to suggest tags for a user's photos in one or more embodiments of the present disclosure. The user first exports calendar or location data to server 12. Alternatively, server 12 can log into third party servers 24 to parse calendar and location data. Alternative sources of calendar or location data can come from a user's calendar program located locally on client device 16. When the user uploads new photos, server 12 attempts to find events from the imported calendar data that match the time frame of the new photos (e.g., the created date in the EXIF data) and suggests possible matches to the user. For example, a button 52 shows “Organize for me” that initiates the matching process.

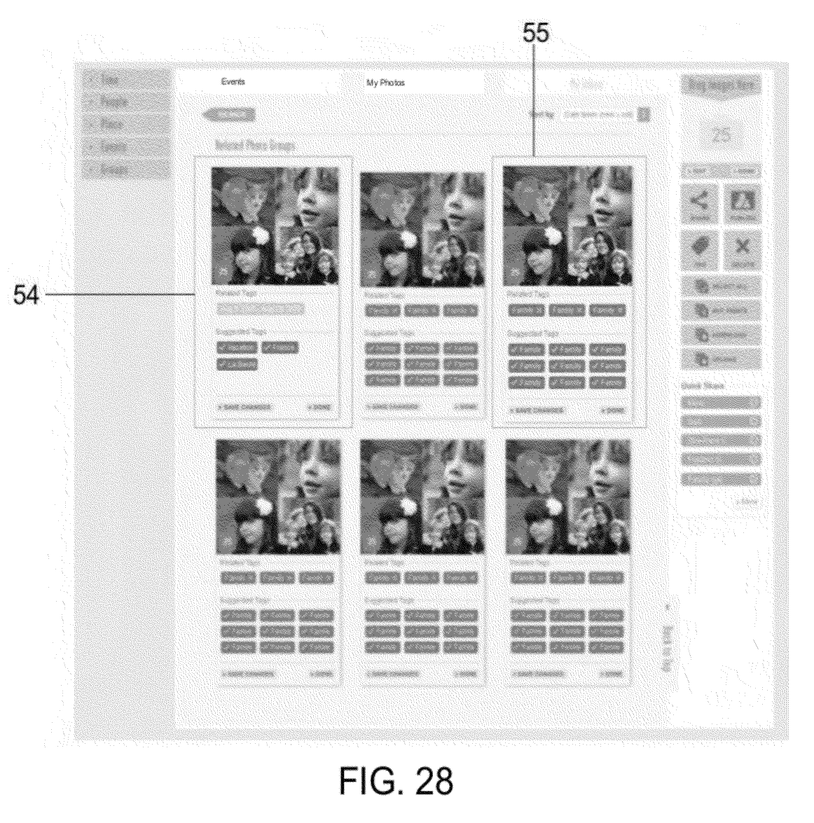

FIG. 28 illustrates how server 12 presents suggested tags to the user based on matches between imported calendar data and time frame of the new image in one or more embodiments of the present disclosure. Server 12 may also suggest other tags from images that share common tags with the new image. When there is an event match, server 12 uses the details of the event from the imported calendar data to automatically generate tags and then suggests them to the user. The user can then choose to apply the suggested tags or create her own. In response to the user clicking button 52 (FIG. 27), server 12 displays results such as 54 and 55 to the user. Result 54 includes under the related tag, the matching time frame of Aug. 5-19, 2009, and suggested tags “Vacation,” “La Baule,” and “France” that server 12 generated from the event match during Aug. 5-19, 2009. Result 54 may also include available tags previously created by the user or a text box for the user to create a new tag. Result 55 represents a set of photos that share common tags, and server 12 also suggests new tags to apply to the images in this result.

In one or more embodiments of the present disclosure, the first user may tag a photo with audio. FIG. 29 illustrates how a user uploads an audio file to server 12, which can then be associated with a photo, in one or more embodiments of the present disclosure. The user may upload the audio file from a client device or a mobile client to server 12, and associate the audio file with multiple photos. In response to clicking an upload button in action tool bar area 42, server 12 presents a dialog box 56 to the user when the file is an audio file. Dialog box 56 includes a browser button for selecting an audio file, a text box for inputting a caption for the audio file, a tags area for adding tags to the audio file, and an upload button for uploading the audio file. For example, dialog box 56 shows the file being uploaded is called “proposal.m4a” and the user has added the “beach” tag to it. Note that the upload button in action tool bar area 42 also allows the user to upload image files.

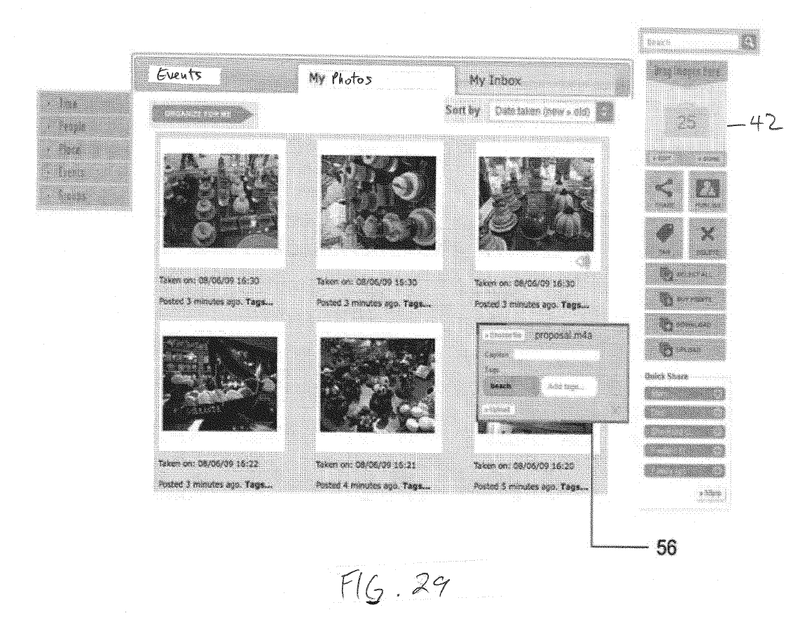

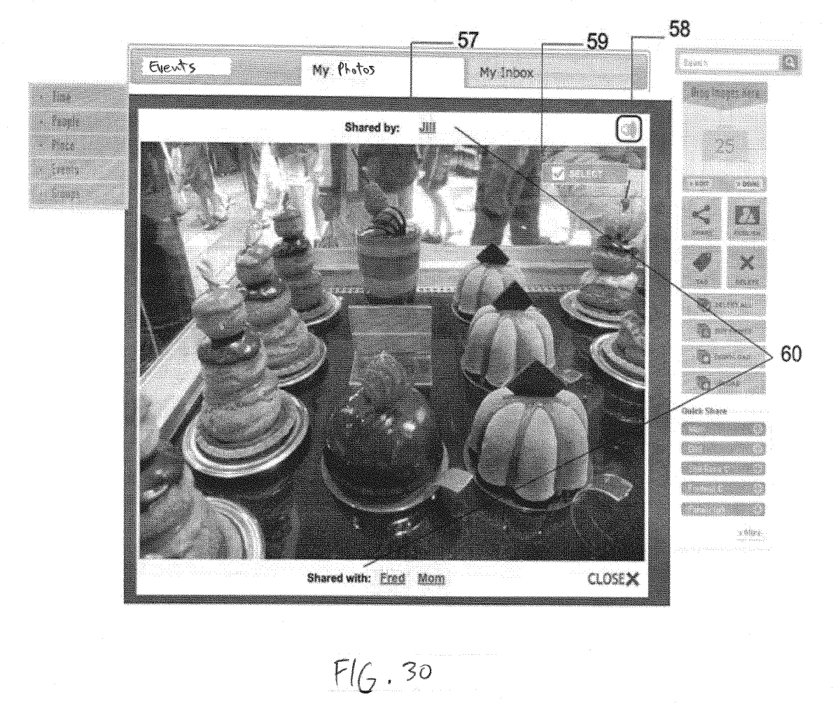

FIG. 30 illustrates how server 12 presents an enlarged photo, including associated audio file and sharing history, after the user selects a thumbnail of the photo in one or more embodiments of the present disclosure. In response to the user selecting the photo, server 12 presents a window 57 with the image, a speaker icon 58 representing an audio file associated with the photo, a select button 59 that a user can click to select the photo, and the user and sharing history 60. When the user clicks icon 58, server 12 plays back the audio file while the user is viewing the image. Select button 59 allows the user to select the photo while the photo is enlarged. Sharing history 60 shows the name of the person that shared the photo with the user, as well as the person or people that the user has shared the photo with, determined from data structures 25 (FIG. 2). For example, sharing history 60 displays “Shared by: Jill,” indicating Jill shared the image with the user, and “Shared with: Fred Mom,” indicating the user has already shared the image with Fred and Mom. If a user clicks on a name, the user will see the sharing history with that person.

In one or more embodiments of the present disclosure, server 12 does not automatically add photos shared by one user with another user into the shared with user's photos view. Instead, the shared photos are first placed in an “Inbox” of the shared with user and, once approved by the shared with user, server 12 places the shared photos into the shared with user's My Photos view 43 (FIG. 23). FIG. 31 illustrates an “Inbox” view 62 in main viewing area 38 (FIG. 26) in one or more embodiments of the present disclosure. Inbox view 62 includes thumbnails of photos that other users have shared with the user. Each inbox item 68 includes a small icon of the sender displayed with the received photo. The user may use searching and filtering area 40 to filter the inbox items by time, people, places, events, and groups. In response to parameters set by the user, server 12 filters the photos and then displays the result. The user may use action toolbar area 66 to apply different actions to one or more selected photos. These actions include share, add, viewed, delete, select all, and download. In response to the user selecting to add one or more selected photos, server 12 moves the selected photos from Inbox view 62 to My Photos view 43 (FIG. 24). When the sender or the recipient of the photo adds or modifies tags to the photo, the other users see the updated tags automatically.

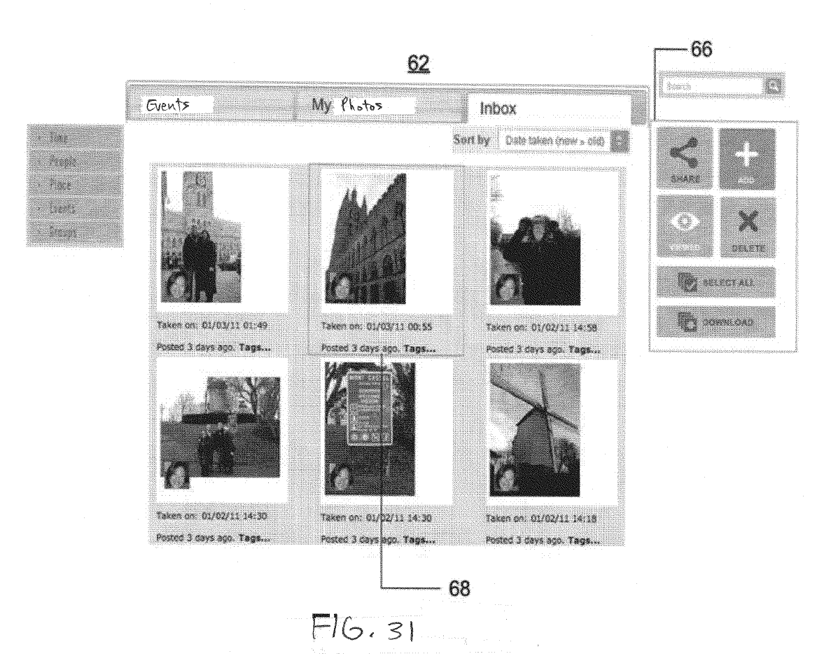

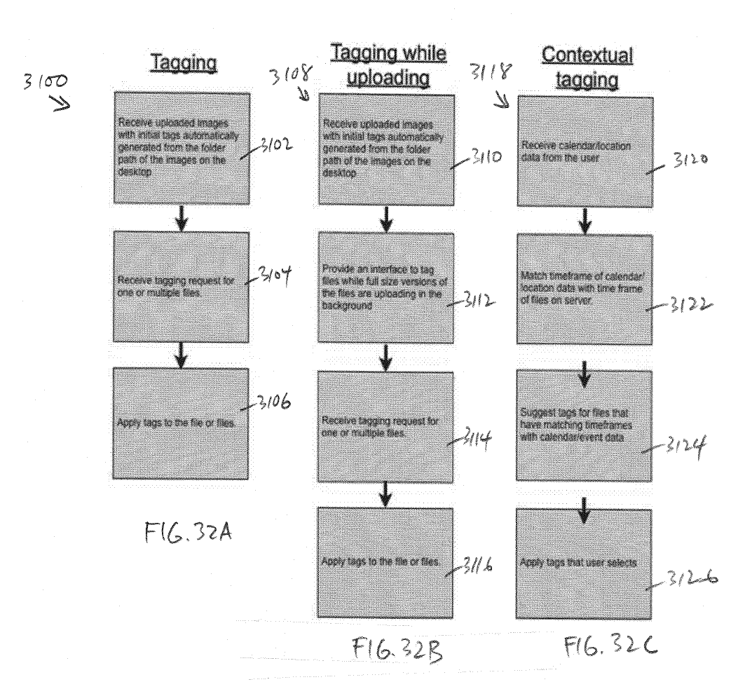

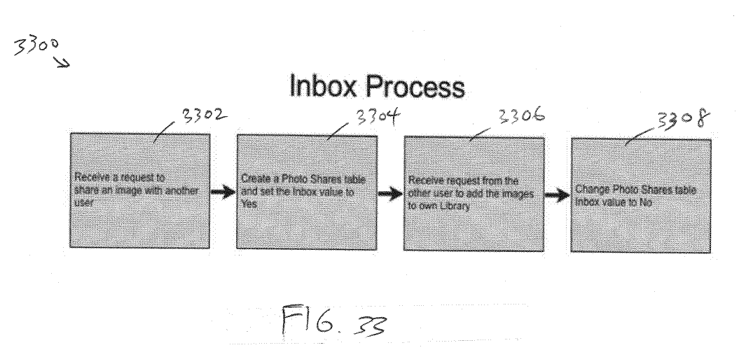

FIG. 32A is a flowchart of a method 3100 for server 12 to tag multiple photos in one or more embodiments of the present disclosure. When new photos are uploaded, server 12 may also receive a set of tags that were automatically generated from a desktop client application based on the folder path of the images. Then, a user can request to tag one or multiple photos and the server will apply the tags to those photos. Method 3100 may begin in block 3102.

In block 3102, server 12 receives uploaded photos and any initial tags generated from the paths to the photos on a client device. Block 3102 may be followed by block 3104. In block 3104, server 12 receives a request to tag one or more selected photos with the same tag. Block 3104 may be followed by block 3106. In block 3106, server 12 applies the tag to the selected photos by generating tags table 30 (FIG. 1).

FIG. 32B is a flowchart of a method 3108 for server 12 to provide tagging while uploading in one or more embodiments of the present disclosure. The tagging while uploading process is similar to the regular tagging process, except the tagging occurs while the full-size files are still being uploaded in the background. Method 3108 may begin in block 3110. In block 3110, server 12 receives uploaded photos and any initial tags generated from the paths to the photos on a client device. Block 3110 may be followed by block 3112. In block 3112, server 12 provides a user interface (e.g., tagging while uploading window 36 in FIG. 22) for the user to tag the photos while the full-size versions of the photos are uploaded in the background. Block 3112 may be followed by block 3114. In block 3114, server 12 receives a request to tag one or more selected photos with the same tag. Block 3114 may be followed by block 3116. In block 3116, server 12 applies the tag to the selected photos by generating tags table 30 (FIG. 1).

FIG. 32C is a flowchart of a method 3118 for server 12 to perform contextual tagging in one or more embodiments of the present disclosure. Method 3118 may begin in block 3120. In block 3120, the user first imports calendar/location data to server 12. The calendar/location data may be from a client device or a third party service provider. Block 3120 may be followed by block 3122. In block 3122, server 12 matches the time frame of the calendar/location data (e.g., a calendar items) with the time frame of the photos on the server. Block 3122 may be followed by block 3124. In block 3124, server 12 suggests tags for photos that have matching time frames with the calendar items using the names of the calendar items. Block 3124 may be followed by block 3126. In block 3126, if the user chooses, server 12 applies the suggested tags to the photos. Server 12 may also update the calendar items at the client device or the third party service provider with the URL of the event webpage so the user can easily access the event webpage.

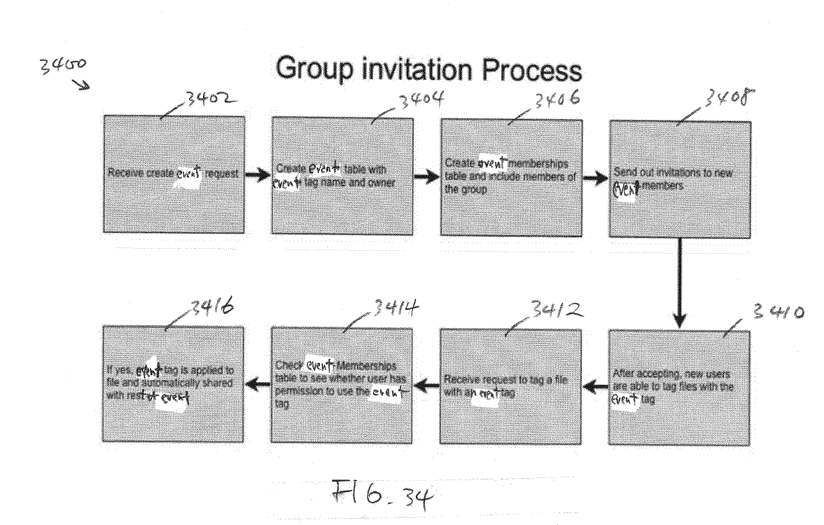

FIG. 33 is a flowchart of a method 3300 for server 12 to implement the inbox process in one or more embodiments of the present disclosure. Method 3300 may begin in block 3302. In block 3302, server 12 receives a request to share a photo with another user. Block 3302 may be followed by block 3304. In block 3304, server 12 creates a new photo shares table 25 (FIG. 2) and the inbox state in the table is set to “yes” to create an inbox item for the shared with user. Block 3304 may be followed by block 3306. In block 3306, when a shared with user wishes to add photos from her inbox to her own library, server 12 receives a request to add the photos to her library. Block 3306 may be followed by block 3308. In block 3308, server 12 changes the value for the inbox state in photo shares table 25 for the photo to “no.”

FIG. 34 is a flowchart of a method 3400 for server 12 to create in one or more embodiments of the present disclosure. Method 3400 may begin in block 3402. In block 3402, server 12 receives a request from a user to create a new event. Block 3402 may be followed by block 3404. In block 3404, server 12 creates a new events table 34A identifying the event name (the event tag) and the owner. Block 3404 may be followed by block 3406. In block 3406, server 12 receives the users to be invited to the event from the user and creates an event memberships table 34B with all the user names. Block 3406 may be followed by block 3408. In block 3408, server 12 sends out invitations to join the event. Block 3408 may be followed by block 3410. In block 3410, once the new event members accept, server 12 adds them to event memberships table 34B and they are able to start tagging files with the event tag. Block 3410 may be followed by block 3412. In block 3412, server 12 receives a request to tag a photo with the event tag from a user. Block 3412 may be followed by block 3414. In block 3414, server 12 checks event memberships table 34B for the event tag to see whether the user has permission to use the event tag. Block 3414 may be followed by block 3416. In block 3416, if the user is an event member, server 12 applies the group tag to the photos, which is automatically shared with the rest of the event members.

Various other adaptations and combinations of features of the embodiments disclosed are within the scope of the invention. Numerous embodiments are encompassed by the following claims.

1. A method for a server to provide a media sharing service, comprising:
creating an event for sharing media with members of the event;
receiving, from a first user on a first client device, a request to add one or more media files to the event, the first user being one of the members of the event;
in response to the request to add the one or more media files to the event, tagging the one or more media files with an event tag of the event for sharing with the members of the event;
receiving, from a second user on a second client device, a request to access the event, the second user being one of the members of the event; and
in response to the request to access the event, looking up the one or more media files with the event tag and transmitting event information including copies of the one or more media files to the second client device.

2. The method of claim 1, wherein the request to add the one or more media files comprises a request to upload the one or more media files to the event or tagging the one or more medial already uploaded to the server.

3. The method of claim 1, wherein the one or more media files comprise photos and the copies of the one or more media files comprise thumbnails of the photos.

4. The method of claim 1, further comprising:
receiving, from the first user on the first client device, another request to add an other one or more of media files to an other event, the first user being a member of the other event; and
in response to the request to add the other one or more of media files to the other event, tagging the other one or more media files with an other event tag of the other event for sharing with other members of the other event.

5. The method of claim 1, further comprising:
receiving a request to create, wherein the event is created in response to the request to create the event.

6. The method of claim 5, wherein the request to create the event specifies the members of the event.

7. The method of claim 1, further comprising:
importing calendar data from a source, the calendar data including a calendar item having one or more of a date and a location, wherein the event is created based on the calendar item;
matching the calendar item with a plurality of media files stored by the server in the database based on the one or more of the date and the location;
transmitting a suggestion to tag the one or more media files with the event tag; and
when the suggestion is accepted, tagging the plurality of media files with the event tag for sharing with the members of the event.

8. The method of claim 7, further comprising:
updating the calendar item at the source with an identifier to access the event.

9. The method of claim 1, wherein transmitting the event information comprises:
transmitting a yearly calendar wherein dates in a year having events are visually indicated; and
when a month in the year is selected by the second user, transmitting:
a monthly calendar wherein one or more dates in the month having one or more events are visually indicated; and
one or more groups of thumbnails of photos from the one or more events.

10. The method of claim 9, wherein transmitting the event information comprises:
providing an event filter for the yearly and the monthly calendars.

11. The method of claim 1, further comprising:
transmitting an other event information representing the event from different perspectives, the other event information being composed from media files of the event from different users, the media files comprising photos.

12. The method of claim 11, further comprising:
generating the other event information, comprising:
extracting camera locations from the photos;
grouping the photos by the camera locations; and
generating the other event information with a plurality of geographical sections, wherein the photos are placed in the geographical sections based on the camera locations.

13. The method of claim 1, further comprising:
receiving a request to tag an image file with an audio file; and
in response to the request to tag the image file with the audio file, tagging the image file with the audio file, wherein transmitting the event information includes transmitting the image file and the audio file.

14. The method of claim 1, wherein when the second user provides an identifier of the event information to a third user on a third client device, the method further comprises:
receiving a request for the event information including the identifier from the third user;
determining the third user is not one of the members of the event;
transmitting a request to an event creator to add the third user to the event; and
when the event creator accepts the third user, adding the third user as one of the members of the event.

15. The method of claim 1, further comprising:
receiving a selection of multiple media files for simultaneous download;
creating a compressed file with the multiple media files that is downloadable from a link; and
transmitting the link.

16. The method of claim 1, further comprising:
providing an interface for the first user to upload a plurality of media files and tag the plurality of media files while the plurality media files is uploaded.

17. The method of claim 1, further comprising:
transmitting to the first client device another event information comprising membership requests to multiple events created by the first user.

18. The method of claim 1, further comprising:
transmitting to the first client device another event information comprising a summary listing the most recent comments for each media file having one or more comments.

19. A method for a first client device to join an event for sharing media via a server, comprising:
receiving an invitation to join the event from a second client device;
decoding the invitation to retrieve credentials;
transmitting the credentials to the server; and
when the server verifies the credentials, receiving access to media files related to the event from the server.

20. The method of claim 19, wherein the invitation comprises a barcode or a near field communication message.

21. A method for a mobile client device to participate in a media sharing service provided by a server, comprising:
receiving a selection of an event for sharing media with members of the event;
receiving a request to take a new photo of the event;
in response to the request, capturing the new photo using the mobile client device; and
uploading the new photo to the server and requesting the server to tag the new photo with an event tag of the event so the new photo is included in the event and accessible to the members of the event.

22. The method of claim 21, further comprising:
receiving an other request to add an existing photo on the mobile client device to the event; and
in response to the other request, uploading the existing photo to the server and requesting the server to tag the existing photo with the event tag so the existing photo is included in the event and accessible to the members of the event.
